(19) United States
(12) Patent Application Publication
(10) Pub. No.: US 2025/0112519 A1
(43) Pub. Date: Apr. 3, 2025

(54) MOTOR UNIT

(71) Applicant: MAKITA CORPORATION, Anjo-shi (JP)

(72) Inventor: Hajime Takeuchi, Anjo-shi (JP)

(73) Assignee: MAKITA CORPORATION, Anjo-shi (JP)

(21) Appl. No.: 18/882,012

(22) Filed: Sep. 11, 2024

(30) Foreign Application Priority Data
Oct. 2, 2023 (JP) 2023-171592

(51) Int. Cl. H02K 5/24; H02K 7/14; H02K 9/06; H02K 11/00; H02K 11/33

(52) U.S. Cl. CPC H02K 5/24; H02K 7/145; H02K 9/06; H02K 11/0094; H02K 11/33; H02K 2211/03

(57) ABSTRACT

A motor unit may include: a motor including a motor shaft extending in a first direction; a body housing disposed on an outer side of the control circuit board and the motor housing; a first fixing part configured to be fixed to the working unit; a first and second vibration-proof members disposed between the body housing and the motor housing. The first fixing part is placed on a placement surface when the motor unit is placed on the placement surface. In an up-down direction perpendicular to the placement surface, at least a part of the first vibration-proof member and at least a part of the second vibration-proof member may be disposed below an upper end of the motor when the motor unit is placed on the placement surface. When the motor unit is viewed along the first direction, the motor may be disposed between the first second vibration-proof members.

### REFERENCE TO RELATED APPLICATION

This application claims priority to Japanese Patent Application No. 2023-171592, filed on Oct. 2, 2023, the entire contents of which are hereby incorporated by reference into the present application.

### TECHNICAL FIELD

This disclosure herein relates to a motor unit.

### BACKGROUND ART

WO 2020/049617 A1 describes a motor unit. The motor unit is configured to be detachably attached to a working unit to drive the working unit. The motor unit includes a motor including a motor shaft extending in a first direction and configured to drive the working unit, a control circuit board configured to drive the motor, a motor housing supporting the motor, a body housing disposed on an outer side of the control circuit board and the motor housing, a first fixing part configured to be fixed to the working unit, a first vibration-proof member disposed between the body housing and the motor housing, a second vibration-proof member disposed between the body housing and the motor housing, and a third vibration-proof member disposed between the body housing and the motor housing. The first fixing part is configured to be placed on a placement surface when the motor unit is placed on the placement surface, and is disposed substantially parallel to the motor shaft.

### SUMMARY

In the above motor unit, the arrangement of the first, second, and third vibration-proof members is asymmetrical with respect to the motor. In this case, vibration of the motor cannot be sufficiently damped.

In the motor unit described above, it is necessary to define a flow space using member(s) that are different from the first to third vibration-proof members to cool the control circuit board. Due to this, the number of parts in the motor unit increases.

The description herein aims to provide at last one of a motor unit configured to sufficiently dampen motor vibration and a motor unit configured to reduce the number of parts in the motor unit while dampening motor vibration.

A motor unit disclosed herein may be configured to be detachably attached to a working unit to drive the working unit. The motor unit may comprise: a motor comprising a motor shaft extending in a first direction and configured to drive the working unit; a control circuit board configured to drive the motor; a motor housing supporting the motor; a body housing disposed on an outer side of the control circuit board and the motor housing; a first fixing part configured to be fixed to the working unit; a first vibration-proof member disposed between the body housing and the motor housing; and a second vibration-proof member disposed between the body housing and the motor housing. The first fixing part may be configured to be placed on a placement surface when the motor unit is placed on the placement surface, the first fixing part being disposed substantially parallel to the motor shaft. In an up-down direction perpendicular to the placement surface, at least a part of the first vibration-proof member and at least a part of the second vibration-proof member may be disposed below an upper end of the motor when the motor unit is placed on the placement surface. When the motor unit is viewed along the first direction, the motor may be disposed between the first vibration-proof member and the second vibration-proof member.

According to the above configuration, at least a part of the first vibration-proof member and at least a part of the second vibration-proof member are disposed below the upper end of the motor, and the first and second vibration-proof members are disposed with the motor in between them. Due to this, the first and second vibration-proof members are symmetrically positioned with respect to the motor. This allows the vibration of the motor to be sufficiently damped.

Another motor unit disclosed herein may be configured to be detachably attached to a working unit to drive the working unit. The motor unit may comprise: a motor comprising a motor shaft extending in a first direction and configured to drive the working unit; a control circuit board configured to drive the motor; a motor housing supporting the motor; a body housing disposed on an outer side of the control circuit board and the motor housing; a second fixing part configured to be fixed to the working unit; a first vibration-proof member disposed between the body housing and the motor housing; and a second vibration-proof member disposed between the body housing and the motor housing. The motor shaft may be substantially perpendicular to the second fixing part. In an up-down direction perpendicular to a placement surface, at least a part of the first vibration-proof member and at least a part of the second vibration-proof member may be disposed below an upper end of the motor when the motor unit is placed on the placement surface. When the motor unit is viewed along the first direction, the motor may be disposed between the first vibration-proof member and the second vibration-proof member.

According to the above configuration, at least a part of the first vibration-proof member and at least a part of the second vibration-proof member are positioned below the upper end of the motor, and the first and second vibration-proof members are positioned with the motor in between them. Due to this, the first and second vibration-proof members are symmetrically positioned with respect to the motor. This allows the vibration of the motor to be sufficiently damped.

Another motor unit disclosed herein may be configured to be detachably attached to a working unit to drive the working unit. The motor unit may comprise: a motor comprising a motor shaft extending in a first direction and configured to drive the working unit; a control circuit board configured to drive the motor; a fan fixed to the motor; a motor housing supporting the motor; a board housing supporting the control circuit board; a body housing disposed on an outer side of the motor housing and the board housing; a fixing unit configured to be fixed to the working unit; and a tubular vibration-proof member disposed between the motor housing and the board housing and having a tubular shape. When the fan rotates, air may cool the control circuit board and passes inside the tubular vibration-proof member.

According to the above configuration, when the motor vibrates, the tubular vibration-proof member dampens the vibration of the motor. In addition, air that cools the control circuit board passes inside the tubular vibration-proof member. By using the tubular vibration-proof member, the vibration of the motor can be suppressed and the control circuit board can be cooled with only one component. This reduces the number of parts in the motor unit.

### BRIEF DESCRIPTION OF DRAWINGS

FIG. 1 shows a system 1 of a first embodiment.

FIG. 2 shows a perspective view of a motor unit 10 and a rammer 4a of the first embodiment.

FIG. 3 shows a perspective view of the motor unit 10 and a plate compactor 4b of the first embodiment.

FIG. 4 shows a perspective view of the motor unit 10 and battery packs BP of the first embodiment.

FIG. 5 is a table showing specifications of the motor unit 10, a body housing 12, a motor 86, and the battery packs BP of the first embodiment.

FIG. 6 shows a perspective view of the motor unit 10 and battery pack BP of the first embodiment.

FIG. 7 is a perspective view of a first battery receptacle 22 and a second battery receptacle 24 and a surrounding area thereof in the motor unit 10 of the first embodiment.

FIG. 8 shows a cross-sectional view of a first battery pack BP1 and a second battery pack BP2 and a surrounding area thereof in the motor unit 10 of the first embodiment.

FIG. 9 is a table showing specifications of the motor 86 and the battery packs BP of the first embodiment.

FIG. 10 shows a perspective view of the battery pack BP of the first embodiment.

FIG. 11 shows a cross-sectional view of the first battery receptacle 22 and the first battery pack BP1 and a surrounding area thereof in the motor unit 10 of the first embodiment.

FIG. 12 shows an exploded perspective view of the motor unit 10 of the first embodiment.

FIG. 13 shows a cross-sectional view of the motor unit 10 and battery pack BP of the first embodiment.

FIG. 14 shows a perspective view of a motor housing 84 and the motor 86 of the first embodiment.

FIG. 15 shows a cross-sectional view of an area surrounding an air intake 28a in the motor unit 10 of the first embodiment.

FIG. 16 shows a cross-sectional view of the motor housing 84, the motor 86, and a fan 88 of the first embodiment.

FIG. 17 shows an exploded perspective view of the motor housing 84, the motor 86, and a plate member 92 of the first embodiment.

FIG. 18 shows an exploded perspective view of the motor unit 10 of the first embodiment with the body housing 12 and a support unit 100 removed.

FIG. 19 shows an exploded perspective view of the motor unit 10 of the first embodiment with the body housing 12 and the support unit 100 removed.

FIG. 20 shows a right side view of the motor unit 10 of the first embodiment with the body housing 12 and the support unit 100 removed.

FIG. 21 is a left side view of the motor unit 10 of the first embodiment with the body housing 12 and the support unit 100 removed.

FIG. 22 shows a cross-sectional view of the motor unit 10 of the first embodiment.

FIG. 23 shows a front view of the motor unit 10 of the first embodiment with the body housing 12 removed.

FIG. 24 shows an exploded perspective view of the motor unit 10 of the first embodiment with the body housing 12 removed.

FIG. 25 shows an exploded perspective view of the motor unit 10 of the first embodiment with the body housing 12 removed.

FIG. 26 shows a cross-sectional view of an area surrounding a control unit 102 in the motor unit 10 of the first embodiment.

FIG. 27 shows a left side view of the motor unit 10 and the rammer 4a of the first embodiment.

FIG. 28 shows a front view of the motor housing 84, the motor 86, and a fixing unit 90 of the first embodiment.

FIG. 29 is a perspective view of the rammer 4a of the first embodiment near a fixing platform 308.

FIG. 30 shows an exploded perspective view of the motor unit 10 and the rammer 4a of the first embodiment.

FIG. 31 shows a left side view of the motor unit 10 and the plate compactor 4b of the first embodiment.

FIG. 32 shows an exploded perspective view of a first fixing part 148 and the plate compactor 4b of the first embodiment.

FIG. 33 shows a side view of the motor unit 10 and a slope mower 4c of the first embodiment.

FIG. 34 shows a perspective view of a motor unit 10 and battery packs BP of a second embodiment.

FIG. 35 shows a perspective view of a motor unit 10 and battery pack BP of a third embodiment.

FIG. 36 shows a right side view of a motor unit 10 of a fourth embodiment with a body housing 12 and a support unit 100 removed.

FIG. 37 shows a right side view of a motor unit 10 of a fifth embodiment with a body housing 12 and a support unit 100 removed.

### DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved motor units, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

A motor unit disclosed herein may be configured to be detachably attached to a working unit to drive the working unit. The motor unit may comprise: a motor comprising a motor shaft extending in a first direction and configured to drive the working unit; a control circuit board configured to drive the motor; a motor housing supporting the motor; a body housing disposed on an outer side of the control circuit board and the motor housing; a first fixing part configured to be fixed to the working unit; a first vibration-proof member disposed between the body housing and the motor housing; and a second vibration-proof member disposed between the body housing and the motor housing. The first fixing part may be configured to be placed on a placement surface when the motor unit is placed on the placement surface, the first fixing part being disposed substantially parallel to the motor shaft. In an up-down direction perpendicular to the placement surface, at least a part of the first vibration-proof member and at least a part of the second vibration-proof member may be disposed below an upper end of the motor when the motor unit is placed on the placement surface. When the motor unit is viewed along the first direction, the motor may be disposed between the first vibration-proof member and the second vibration-proof member.

In one or more embodiments, the motor shaft may extend along the placement surface when the motor unit is placed on the placement surface. The first vibration-proof member and the second vibration-proof member may be disposed below a central axis of the motor shaft when the motor unit is placed on the placement surface.

Generally, component(s) of the motor unit are often disposed in the space above the upper end of the motor. According to the above configuration, available space below the central axis of the motor shaft can be used.

In one or more embodiments, the first vibration-proof member and the second vibration-proof member may be disposed above a lower end of the motor when the motor unit is placed on the placement surface.

According to the above configuration, the available space between the central axis of the motor shaft and the lower end of the motor can be used.

In one or more embodiments, the first vibration-proof member may be a first distance away from a perpendicular plane perpendicular to the placement surface and including the first direction. The second vibration-proof member may be the first distance away from the perpendicular plane.

According to the above configuration, the distance between the first vibration-proof member and the perpendicular plane is the same as the distance between the second vibration-proof member and the perpendicular plane. Therefore, the first and second vibration-proof members are symmetrically arranged with respect to the perpendicular plane. This allows the vibration of the motor to be damped more.

In one or more embodiments, a position of a center of gravity of the motor unit in the first direction may be substantially same as each of a center position of the first vibration-proof member in the first direction and a center position of the second vibration-proof member in the first direction.

According to the above configuration, the vibration of the motor can be damped more.

In one or more embodiments, the motor unit may further comprise: a third vibration-proof member disposed between the body housing and the motor housing; and a fourth vibration-proof member disposed between the body housing and the motor housing. At least a part of the third vibration-proof member and at least a part of the fourth vibration-proof member may be disposed above the central axis of the motor shaft when the motor unit is placed on the placement surface. When the motor unit is viewed along the first direction, the motor may be disposed between the third vibration-proof member and the fourth vibration-proof member.

According to the above configuration, the vibration of the motor can be damped more as compared to a configuration in which the motor unit has only the first vibration-proof member and the second vibration-proof member.

In one or more embodiments, the third vibration-proof member may be disposed on a same side as the first vibration-proof member relative to a perpendicular plane perpendicular to the placement surface and including the first direction. The fourth vibration-proof member may be disposed on a same side as the second vibration-proof member relative to the perpendicular plane. A distance between the first vibration-proof member and the third vibration-proof member may be substantially same as a distance between the second vibration-proof member and the fourth vibration-proof member.

According to the above configuration, the third and fourth vibration-proof members are symmetrically arranged with respect to the perpendicular plane. This allows the vibration of the motor to be damped more.

In one or more embodiments, the motor unit may further comprise a plate member fixed to the motor housing. The first vibration-proof member and the second vibration-proof member may be fixed to the plate member and the body housing.

In a configuration in which the first and second vibration-proof members are directly fixed to the motor housing, the configuration of the motor housing becomes complicated. According to the above configuration, the configuration of the motor housing can be suppressed from becoming complicated.

In one or more embodiments, the motor unit may further comprise a second fixing part configured to be fixed to a working unit of a type different from the working unit fixed to the first fixing part.

According to the above configuration, the types of working units configured to use the motor unit can be increased.

In one or more embodiments, the motor unit may further comprise: a fan fixed to the motor; a board housing supporting the control circuit board; and a tubular vibration-proof member disposed between the motor housing and the board housing and having a tubular shape. When the fan rotates, air may cool the control circuit board and passes inside the tubular vibration-proof member.

According to the above configuration, when the motor vibrates, the tubular vibration-proof member dampens the vibration of the motor. In addition, air that cools the control circuit board passes inside the tubular vibration-proof member. By using the tubular vibration-proof member, the vibration of the motor can be suppressed and the control circuit board can be cooled with a single component.

In one or more embodiments, the body housing may comprise: a first battery receptacle configured to have a first battery configured to power the motor detachably attached thereto; and a second battery receptacle configured to have a second battery configured to power the motor detachably attached thereto.

According to the above configuration, the output of the motor unit can be increased or operating time of the motor unit can be extended.

In one or more embodiments, when the motor unit is viewed along the first direction, the control circuit board may at least partially overlap the motor.

According to the above configuration, when the motor unit is viewed along the first direction, the motor unit can be suppressed from becoming larger in the direction perpendicular to the first direction as compared to a configuration in which the control circuit board does not even at least partially overlap the motor.

Another motor unit disclosed herein may be configured to be detachably attached to a working unit to drive the working unit. The motor unit may comprise: a motor comprising a motor shaft extending in a first direction and configured to drive the working unit; a control circuit board configured to drive the motor; a motor housing supporting the motor; a body housing disposed on an outer side of the control circuit board and the motor housing; a second fixing part configured to be fixed to the working unit; a first vibration-proof member disposed between the body housing and the motor housing; and a second vibration-proof member disposed between the body housing and the motor housing. The motor shaft may be substantially perpendicular to the second fixing part. In an up-down direction perpendicular to a placement surface, at least a part of the first vibration-proof member and at least a part of the second vibration-proof member may be disposed below an upper end of the motor when the motor unit is placed on the placement surface. When the motor unit is viewed along the first direction, the motor may be disposed between the first vibration-proof member and the second vibration-proof member.

In one or more embodiments, the motor shaft may extend along the placement surface when the motor unit is placed on the placement surface. The first vibration-proof member and the second vibration-proof member may be disposed below a central axis of the motor shaft when the motor unit is placed on the placement surface.

Generally, the component(s) of the motor unit are often disposed in the space above the upper end of the motor. According to the above configuration, the available space below the central axis of the motor shaft can be used.

In one or more embodiments, the first vibration-proof member may be a first distance away from a perpendicular plane perpendicular to the placement surface and including the first direction. The second vibration-proof member may be the first distance away from the perpendicular plane.

According to the above configuration, the distance between the first vibration-proof member and the perpendicular plane is the same as the distance between the second vibration-proof member and the perpendicular plane. Therefore, the first and second vibration-proof members are symmetrically arranged with respect to the perpendicular plane. This allows the vibration of the motor to be damped more.

In one or more embodiments, the body housing may comprise: a first battery receptacle configured to have a first battery configured to power the motor detachably attached thereto; and a second battery receptacle configured to have a second battery configured to power the motor detachably attached thereto.

According to the above configuration, the output of the motor unit can be increased or the operating time of the motor unit can be extended.

Another motor unit disclosed herein may be configured to be detachably attached to a working unit to drive the working unit. The motor unit may comprise: a motor comprising a motor shaft extending in a first direction and configured to drive the working unit; a control circuit board configured to drive the motor; a fan fixed to the motor; a motor housing supporting the motor; a board housing supporting the control circuit board; a body housing disposed on an outer side of the motor housing and the board housing; a fixing unit configured to be fixed to the working unit; and a tubular vibration-proof member disposed between the motor housing and the board housing and having a tubular shape. When the fan rotates, air may cool the control circuit board and may pass inside the tubular vibration-proof member.

In one or more embodiments, the motor unit may further comprise: a plate member fixed to the motor housing; a support unit supporting the board housing; and a vibration-proof member fixed to the plate member and the support unit.

According to the above configuration, the vibration of the motor is damped by the tubular vibration-proof member and the vibration-proof member. This suppresses the vibration from being transmitted to the control circuit board.

In one or more embodiments, when the motor unit is viewed along the first direction, the tubular vibration-proof member may at least partially overlap the motor.

According to the above configuration, when the motor unit is viewed along the first direction, the motor unit can be suppressed from becoming larger in the direction perpendicular to the first direction as compared to a configuration in which the tubular vibration-proof member does not even at least partially overlap the motor.

In one or more embodiments, the body housing may comprise: a first battery receptacle configured to have a first battery configured to power the motor detachably attached thereto; and a second battery receptacle configured to have a second battery configured to power the motor detachably attached thereto.

According to the above configuration, the output of the motor unit can be increased and/or the operating time of the motor unit can be extended.

### First Embodiment

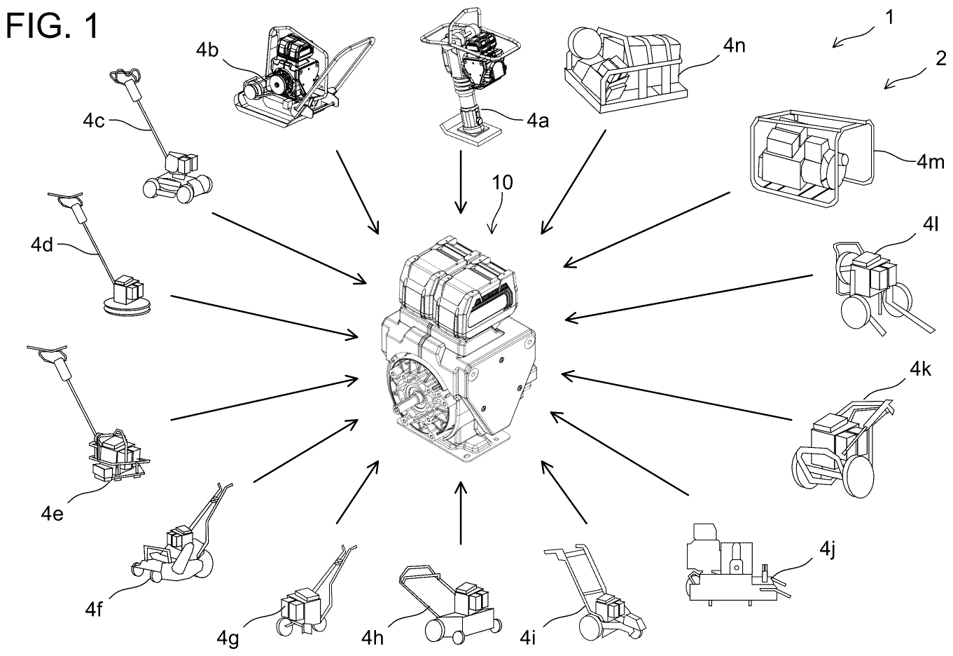

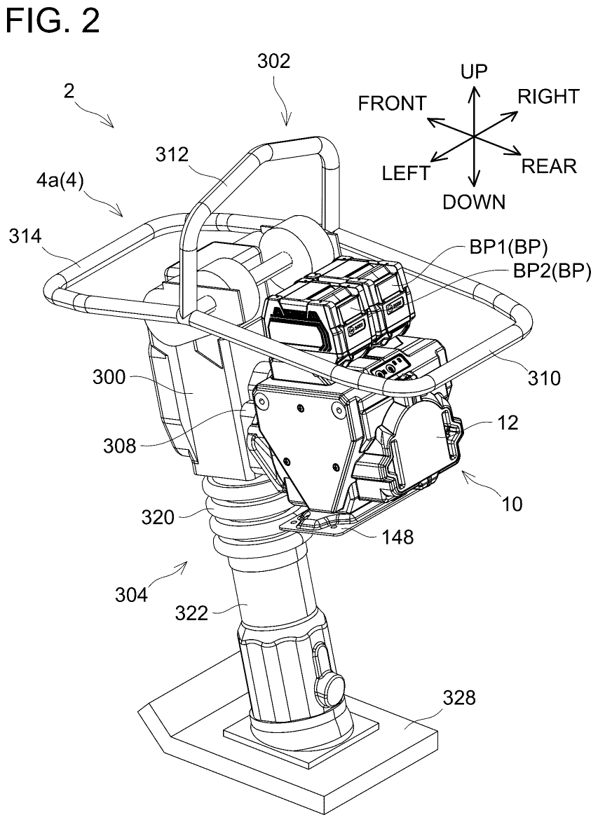

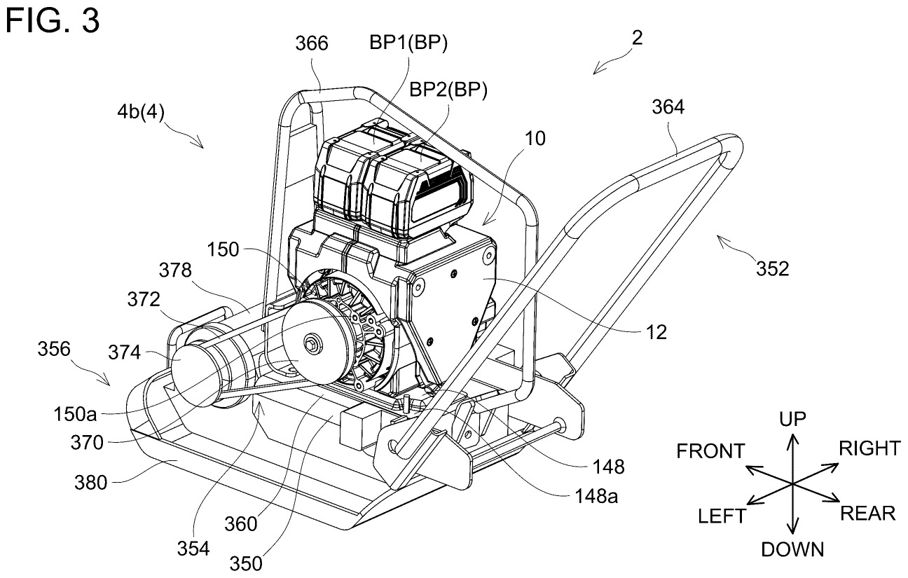

As shown in FIG. 1, a system 1 has multiple types of working units 4 and a motor unit 10. The motor unit 10 is a multi-purpose motor unit. The motor unit 10 can be detachably attached to each of the multiple types of working units 4. Those working units 4 can also have an engine unit detachably attached instead of the motor unit 10. The engine unit is a versatile engine unit, for example, the GX120 engine unit sold by Honda R&D Co. Ltd. That is, the working unit 4 is applicable to both the motor unit 10 and the engine unit. The multiple types of working units 4 are, for example, a rammer 4a, a plate compactor 4b, a slope mower 4c, a trowel 4d, a concrete saw 4e, a reel-type lawn mower 4f, an edger 4g, a detacher 4h, a stump grinder 4i, a compressor 4j, a high pressure washer 4k, a paint sprayer 4l, a trash pump 4m, and a chemical sprayer 4n. The working unit 4 is not limited to the above working unit 4, but may be any other working unit 4 other than the above. For example, as shown in FIG. 2, the motor unit 10 is detachably attached to the rammer 4a. As shown in FIG. 3, the motor unit 10 is detachably attached to the plate compactor 4b. In the following, the configuration in which the motor unit 10 is attached to the working unit 4 is sometimes referred to as a working machine 2. A user works using the working machine 2.

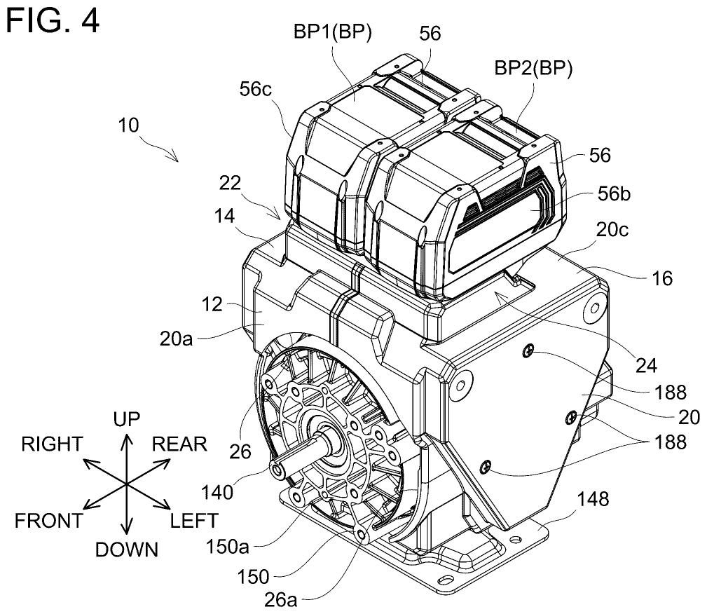

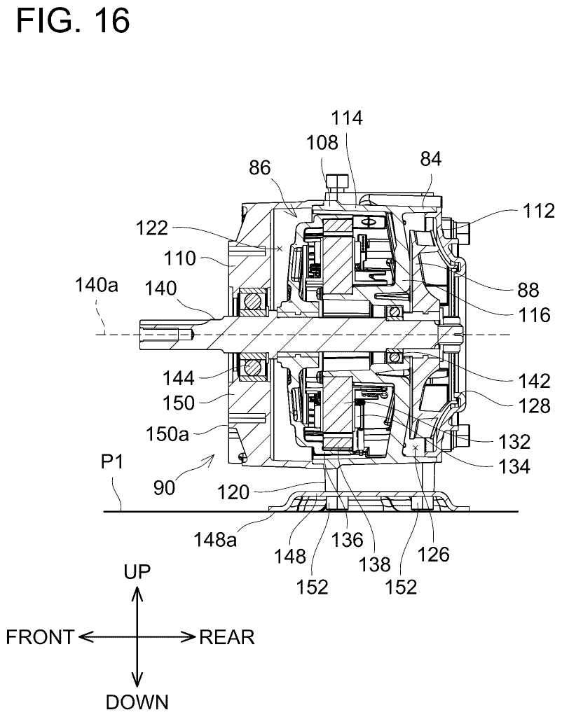

As shown in FIG. 4, the motor unit 10 is operated by power from multiple (in this example, two) battery packs BP. Hereinbelow, one battery pack BP is referred to as a first battery pack BP1 and the other battery pack BP is referred to as a second battery pack BP2. A direction in which a motor shaft 140 of a motor 86 (see FIG. 16) described below extends may be termed a front-rear direction, a direction perpendicular to the front-rear direction may be termed a left-right direction, and a direction perpendicular to the front-rear and left-right directions may be termed an up-down direction. The above front-rear, left-right, and up-down directions are defined to describe the detailed configuration of the motor unit 10. In a working machine 2 in which motor unit 10 and the working unit 4 are combined, front-rear, left-right, and up-down directions of the working machine 2 may differ from the front-rear, left-right, and up-down directions of the motor unit 10.

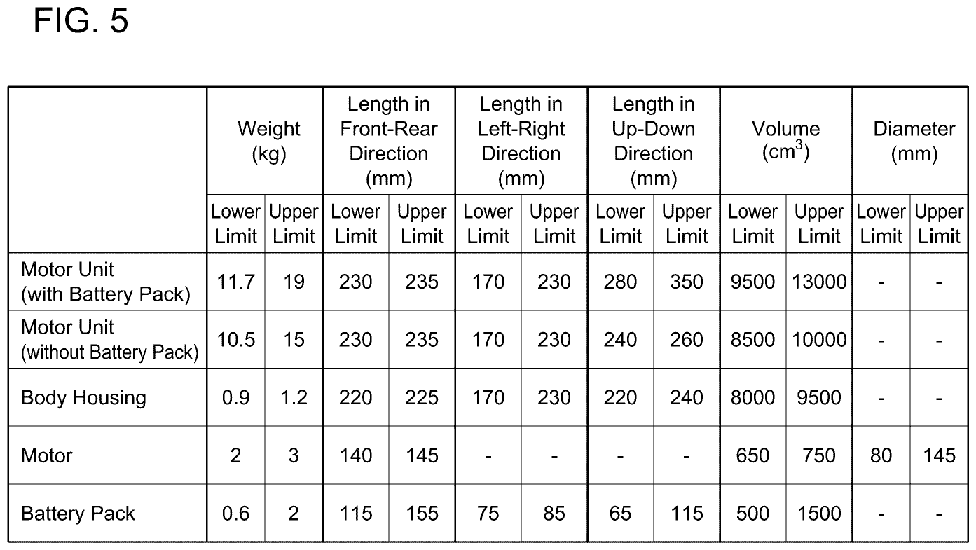

As shown in FIG. 5, for the motor unit 10 including the plurality of battery packs BP, the weight of the motor unit 10 is equal to or more than 11.7 kg and equal to or less than 19 kg. The length of the motor unit 10 in the front-rear direction is equal to or more than 230 mm and equal to or less than 235 mm. The length in the front-rear direction does not include the length of the motor shaft 140 exposed outside the motor unit 10. The length of the motor unit 10 in the left-right direction is equal to or more than 170 mm and equal to or less than 230 mm. The length of the motor unit 10 in the up-down direction is equal to or more than 280 mm and equal to or less than 350 mm. The volume of the motor unit 10 is equal to or more than 9500 cm³ and equal to or less than 13000 cm³.

For the motor unit 10 not including the plurality of battery packs BP, the weight of the motor unit 10 is equal to or more than 10.5 kg and equal to or less than 15 kg. The length of the motor unit 10 in the front-rear direction is equal to or more than 230 mm and equal to or less than 235 mm. The length in the front-rear direction does not include the length of the motor shaft 140 exposed outside the motor unit 10. The length of the motor unit 10 in the left-right direction is equal to or more than 170 mm and equal to or less than 230 mm. The length of the motor unit 10 in the up-down direction is equal to or more than 240 mm and equal to or less than 260 mm.

The volume of the motor unit 10 is equal to or more than 8500 cm³ and equal to or less than 10000 cm³.

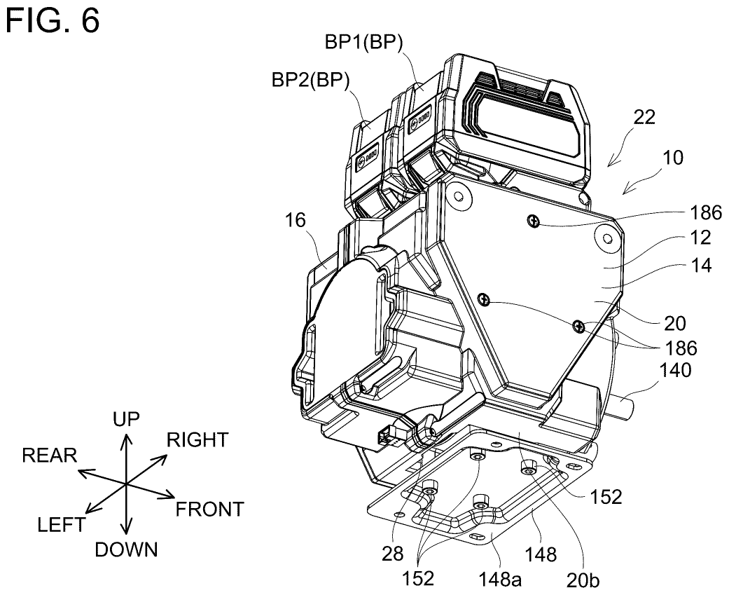

As shown in FIGS. 4 and 6, the motor unit 10 comprises a body housing 12. The body housing 12 is made of, for example, a resin material. As shown in FIG. 5, the weight of the body housing 12 is equal to or more than 0.9 kg and equal to or less than 1.2 kg. The length of the body housing 12 in the front-rear direction is equal to or more than 220 mm and equal to or less than 225 mm. The length of the body housing 12 in the left-right direction is equal to or more than 170 mm and equal to or less than 230 mm. The length of the body housing 12 in the up-down direction is equal to or more than 220 mm and equal to or less than 240 mm. The volume of the body housing 12 is equal to or more than 8000 cm³ and equal to or less than 9500 cm³.

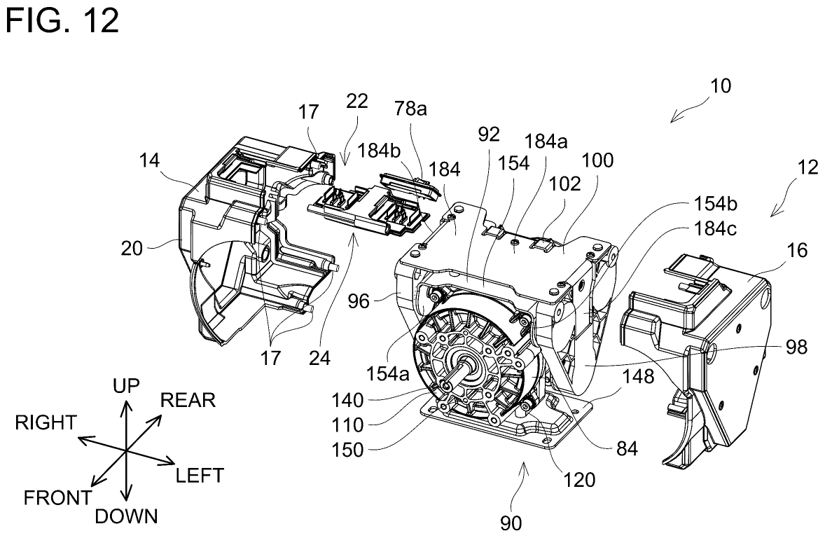

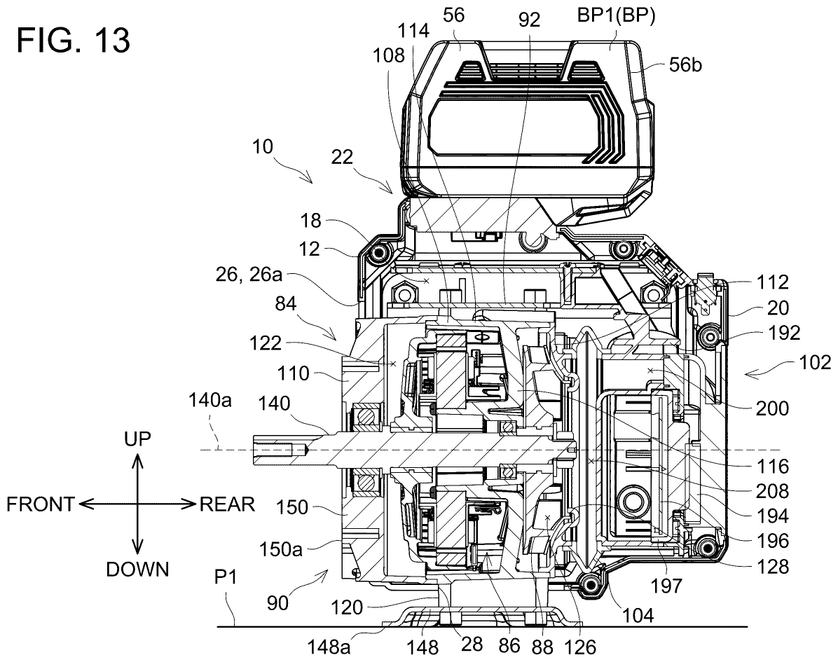

As shown in FIGS. 4 and 6, the body housing 12 has a right body housing 14 and a left body housing 16. The right body housing 14 defines an external shape of a right half of the body housing 12. The left body housing 16 defines an external shape of a left half of the body housing 12. The right body housing 14 and the left body housing 16 are fixed by screws 17 (see FIG. 12). Each of the right body housing 14 and the left body housing 16 has a shape that divides the body housing 12 in half in a plane along the front-rear and up-down directions. A boundary between the right body housing 14 and the left body housing 16 is disposed at the center of the body housing 12 in the left-right direction. An accommodating space 18 (see FIG. 13) is defined between the right body housing 14 and the left body housing 16.

The body housing 12 has an accommodating part 20, a first battery receptacle 22, and a second battery receptacle 24. The accommodating part 20 has the interior accommodating space 18 (see FIG. 13). The accommodating part 20 has a first opening 26 and a second opening 28. The first opening 26 is defined in a front wall 20a of the accommodating part 20. The first opening 26 has a substantially circular cross-sectional shape. The first opening 26 connects the accommodating space 18 to outside of the body housing 12. As shown in FIG. 6, the second opening 28 is defined in a lower wall 20b of the accommodating part 20. The second opening 28 has a substantially rectangular cross-sectional shape. The second opening 28 connects the accommodating space 18 to the outside of the body housing 12.

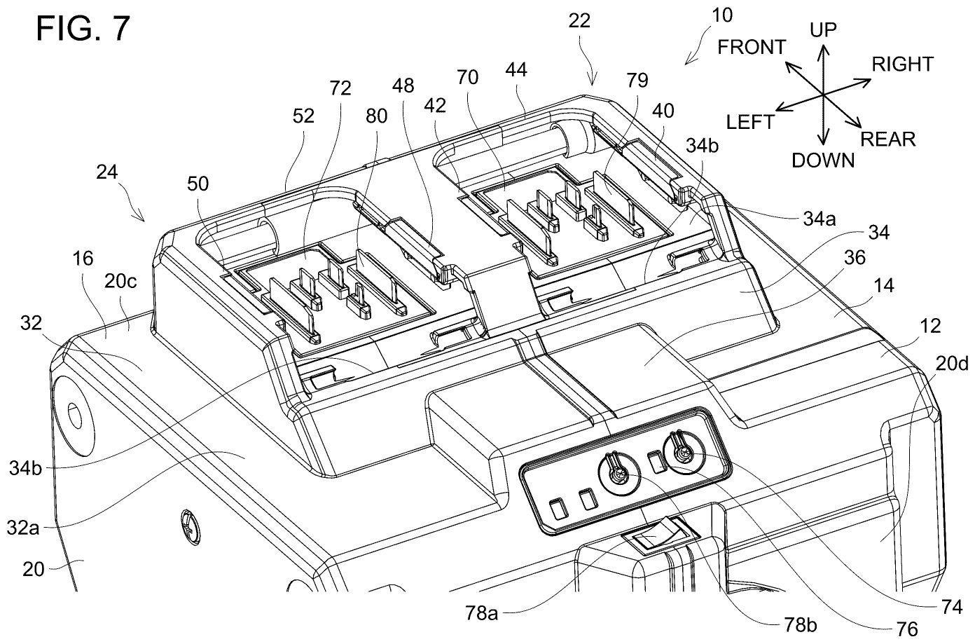

As shown in FIG. 7, an upper wall 20c of the accommodating part 20 has a base 32, a first pyramidal base 34, and a second pyramidal base 36. The first pyramidal base 34 protrudes upward from the base 32. The first pyramidal base 34 has a quadrangular pyramidal shape. An upper surface 34a of the first pyramidal base 34 is positioned above an upper surface 32a of the base 32. Each of the upper surfaces 32a and 34a is perpendicular to the up-down direction.

The second pyramidal base 36 protrudes upward from the base 32. The second pyramidal base 36 is connected to a rear end of the first pyramidal base 34.

The first battery receptacle 22 and the second battery receptacle 24 are disposed on the upper surface 34a of the first pyramidal base 34. The first battery receptacle 22 and the second battery receptacle 24 are arranged side-by-side in the left-right direction. When the motor unit 10 is viewed along the up-down direction, the first battery receptacle 22 does not overlap the second battery receptacle 24.

The first battery receptacle 22 has a first right rail portion 40, a first left rail portion 42, and a first connection portion 44. The first right rail portion 40 and the first left rail portion 42 extend in a front-rear direction. The first right rail portion 40 extends upward from the upper surface 34a of the first pyramidal base 34 and then bends to extend leftward. The first left rail portion 42 extends upward from the upper surface 34a of the first pyramidal base 34, then bends to extend rightward. The first left rail portion 42 opposes the first right rail portion 40 in the left-right direction. The first connection portion 44 connects a front end of the first right rail portion 40 with a front end of the first left rail portion 42.

The second battery receptacle 24 has a second right rail portion 48, a second left rail portion 50, and a second connection portion 52. The second right rail portion 48 and the second left rail portion 50 extend in the front-rear direction. The second right rail portion 48 extends upward from the upper surface 34a of the first pyramidal base 34, and then bends to extend leftward. The second left rail portion 50 is integrated with the first right rail portion 40. The second left rail portion 50 extends upward from the upper surface 34a of the first pyramidal base 34, and then bends to extend rightward. The second left rail portion 50 is opposite the second right rail portion 48 in the left-right direction. The second connection portion 52 connects a front end of the second right rail portion 48 with a front end of the second left rail portion 50.

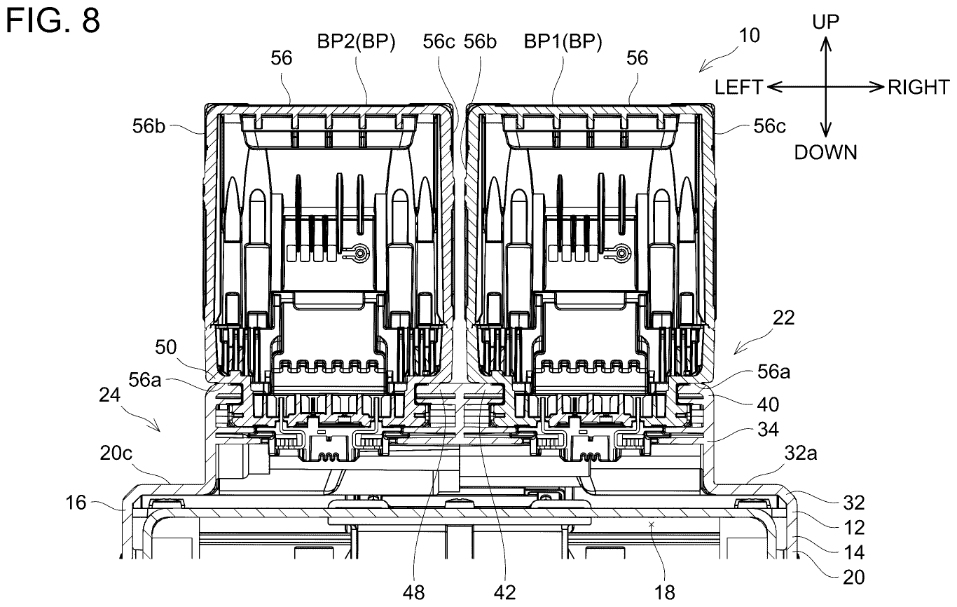

As shown in FIG. 8, the first battery pack BP1 is attached to the first battery receptacle 22. The second battery pack BP2 is attached to the second battery receptacle 24. In the present embodiment, the configuration of the first battery pack BP1 is identical to that of the second battery pack BP2. For this reason, the first battery pack BP1 is exemplified below.

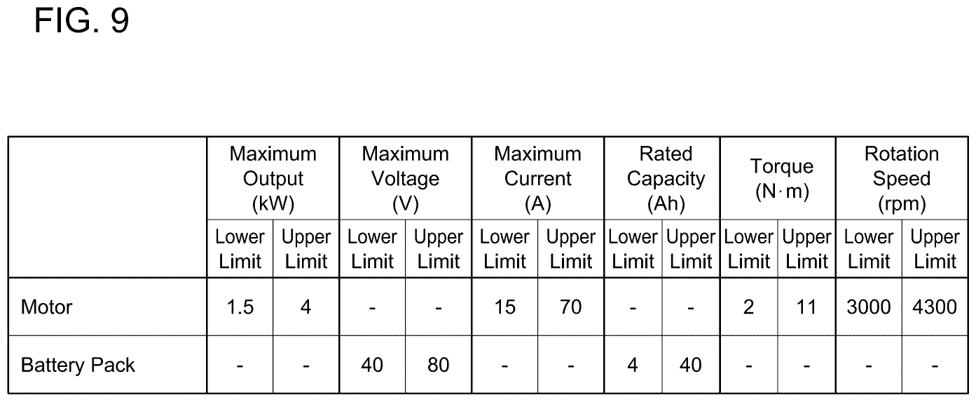

The first battery pack BP1 includes a rechargeable battery that can be charged and discharged, for example, a lithium-ion battery. As shown in FIG. 5, the weight of the first battery pack BP1 is equal to or more than 0.6 kg and equal to or less than 2 kg. The length of the first battery pack BP1 in the front-rear direction is equal to or more than 115 mm and equal to or less than 155 mm. The length of the first battery pack BP1 in the left-right direction is equal to or more than 75 mm and equal to or less than 85 mm. The length of the first battery pack BP1 in the up-down direction is equal to or more than 65 mm and equal to or less than 115 mm. The volume of the first battery pack BP1 is equal to or more than 500 cm³ and equal to or less than 1500 cm³. As shown in FIG. 9, a maximum voltage value of the first battery pack BP1 is equal to or more than 40 V and equal to or less than 80 V. A rated capacity of the first battery pack BP1 is equal to or more than 4 Ah and equal to or less than 40 Ah. In a variant, the configuration of the first battery pack BP1 (i.e., dimensions, maximum voltage value, and rated capacity) may be different from the configuration of the second battery pack BP2 (i.e., dimensions, maximum voltage value, and rated capacity).

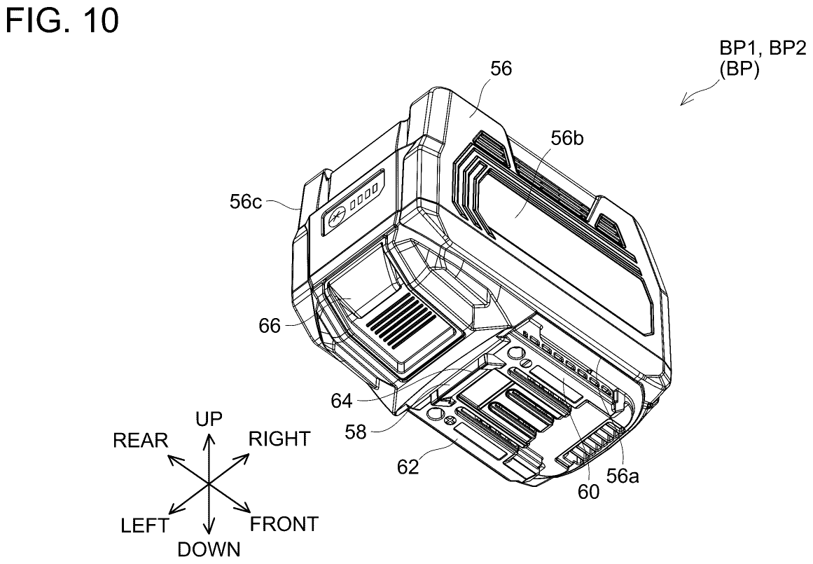

As shown in FIG. 10, the first battery pack BP1 has a battery housing 56, a hook 58, a right battery rail 60, and a left battery rail 62. The battery housing 56 houses rechargeable secondary battery cells, e.g., lithium-ion battery cells therein.

The hook 58 is movably attached to a lower surface 56a of the battery housing 56. The hook 58 has an engagement portion 64 and an operation portion 66. The engagement portion 64 is, for example, an engagement claw. The engagement portion 64 typically protrudes outside of the battery housing 56. When the operation portion 66 is pushed into the battery housing 56, the entire engagement portion 64 moves into the interior of the battery housing 56.

The right battery rail 60 and left battery rail 62 protrude from the lower surface 56a of the battery housing 56. The right battery rail 60 and the left battery rail 62 extend in the front-rear direction. The right battery rail 60 is arranged side-by-side with the left battery rail 62 in the left-right direction. With respect to the left-right direction, the engagement portion 64 is positioned between the right battery rail 60 and the left battery rail 62. The right battery rail 60 extends downward from the lower surface 56a of the battery housing 56, then bends to extend rightward. The left battery rail 62 extends downward from the lower surface 56a of the battery housing 56, then bends to extend leftward.

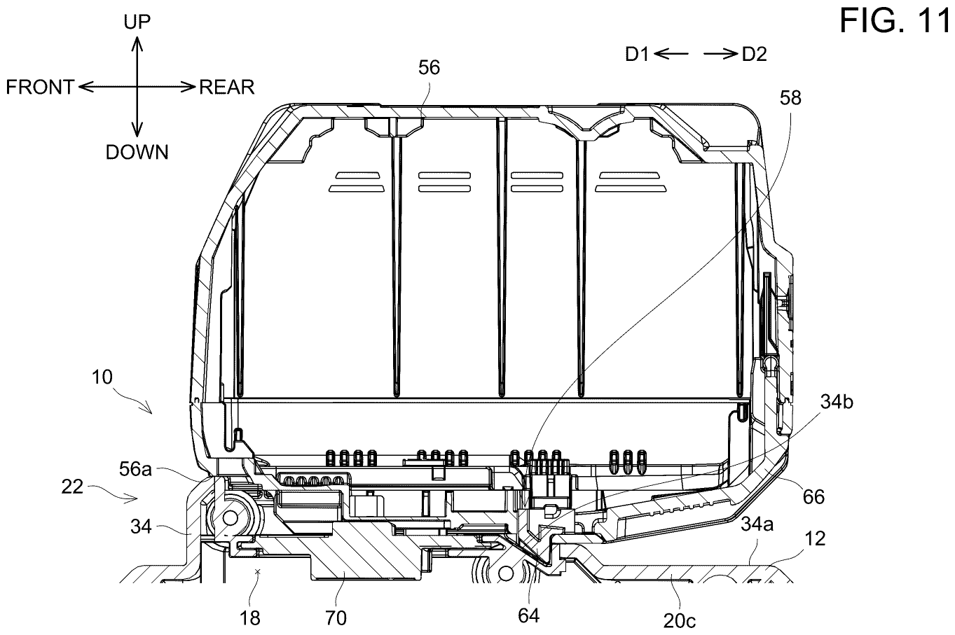

As shown in FIG. 11, when the first battery pack BP1 is slid in an attaching direction D1, the first battery pack BP1 is guided by the first right rail portion 40 (see FIG. 7) and the first left rail portion 42 (see FIG. 7) and slides on the upper surface 34a of the first pyramidal base 34. The attaching direction D1 is directed frontward. As a result, the right battery rail 60 (see FIG. 10) is slidably engaged with the first right rail portion 40, and the left battery rail 62 (see FIG. 10) is slidably engaged with the first left rail portion 42. When the first battery pack BP1 slides on the upper surface 34a and the engagement portion 64 contacts the upper surface 34a, the engagement portion 64 is pushed into the battery housing 56 by the upper surface 34a. The upper surface 34a has a recessed groove 34b recessed from the upper surface 34a. When the engagement portion 64 reaches the recessed groove 34b, it exits out from inside the battery housing 56 and engages with the upper surface 34a in the recessed groove 34b. Due to this, the first battery pack BP1 is attached to the first battery receptacle 22. When the operation portion 66 is pushed in, the engagement portion 64 slips out of the recessed groove 34b, so that the first battery pack BP1 is removed from the first battery receptacle 22 by sliding the first battery pack BP1 in a detaching direction D2. The detaching direction D2 is opposite to the attaching direction D1 and is directed rearward. Although omitted in the drawings, an attaching direction for attaching the second battery pack BP2 to the second battery receptacle 24 is the same as the attaching direction D1. A detaching direction for removing the second battery pack BP2 from the second battery receptacle 24 is the same as the detaching direction D2.

As shown in FIG. 8, when the first battery pack BP1 is attached to the first battery receptacle 22 and the second battery pack BP2 is attached to the second battery receptacle 24, the lower surface 56a of the battery housing 56 of the first battery pack BP1 is in contact with the first battery receptacle 22 from above, and the lower surface 56a of the battery housing 56 of the second battery pack BP2 is in contact with the second battery receptacle 24 from above. A left side surface 56b of the battery housing 56 of the first battery pack BP1 is opposite a right side surface 56c of the battery housing 56 of the second battery pack BP2 in the left-right direction. The left side surface 56b of the battery housing 56 of the first battery pack BP1 is substantially parallel to the right side surface 56c of the battery housing 56 of the second battery pack BP2. There is no wall including the accommodating part 20 between the left side surface 56b of the battery housing 56 of the first battery pack BP1 and the right side surface 56c of the battery housing 56 of the second battery pack BP2. A distance between the left side surface 56b of the battery housing 56 of the first battery pack BP1 and the right side surface 56c of the battery housing 56 of the second battery pack BP2 is equal to or less than 175 mm. In a variant, the distance between the left side surface 56b of the battery housing 56 of the first battery pack BP1 and the right side surface 56c of the battery housing 56 of the second battery pack BP2 may be equal to or less than 350 mm.

As shown in FIG. 7, the motor unit 10 has a first battery terminal 70, a second battery terminal 72, a main power switch 74, a display panel 76, an operation switch 78a, and a speed change switch 78b. The first battery terminal 70 and the second battery terminal 72 are disposed on the upper surface 34a of the first pyramidal base 34. The first battery terminal 70 is surrounded by the first battery receptacle 22. The first battery terminal 70 comprises a plurality of first terminal members 79. The first terminal members 79 are electrically connected to terminal members (not shown) of the first battery pack BP1 when the first battery pack BP1 is attached to the first battery receptacle 22.

The second battery terminal 72 is surrounded by the second battery receptacle 24. The second battery terminal 72 comprises a plurality of second terminal members 80. The second terminal members 80 are electrically connected to the terminal members (not shown) of the second battery pack BP2 when the second battery pack BP2 is attached to the second battery receptacle 24. In the present embodiment, when the first battery pack BP1 is attached to the first battery receptacle 22 and the second battery pack BP2 is attached to the second battery receptacle 24, the first battery pack BP1 and the second battery pack BP2 are electrically connected in series. In a variation, the second terminal members 80 may be electrically connected in parallel with the first terminal members 79.

The main power switch 74 and the display panel 76 are disposed on the second pyramidal base 36. The main power switch 74 is configured to switch the motor unit 10 between on and off states. The display panel 76 lights up when the motor unit 10 is in an on state.

An operation switch 78a is disposed behind the main power switch 74 and the display panel 76. The operation switch 78a is a rocker switch. When a right portion of the operation switch 78a is pushed into the body housing 12, a left portion of the operation switch 78a exits out from inside the body housing 12, and when the left portion of the operation switch 78a is pushed into the body housing 12, the right portion of the operation switch 78a exits out from inside the body housing 12. When the left portion of the operation switch 78a is pushed into the body housing 12 when the motor unit 10 is on, the motor unit 10 operates. While the motor unit 10 is operating, when the right portion of the operation switch 78a is pushed into the body housing 12, the motor unit 10 stops.

The speed change switch 78b is disposed on the second pyramidal base 36. The speed change switch 78b is disposed on a left side of the display panel 76. The speed change switch 78b changes the rotation speed of the motor 86, which will be described later.

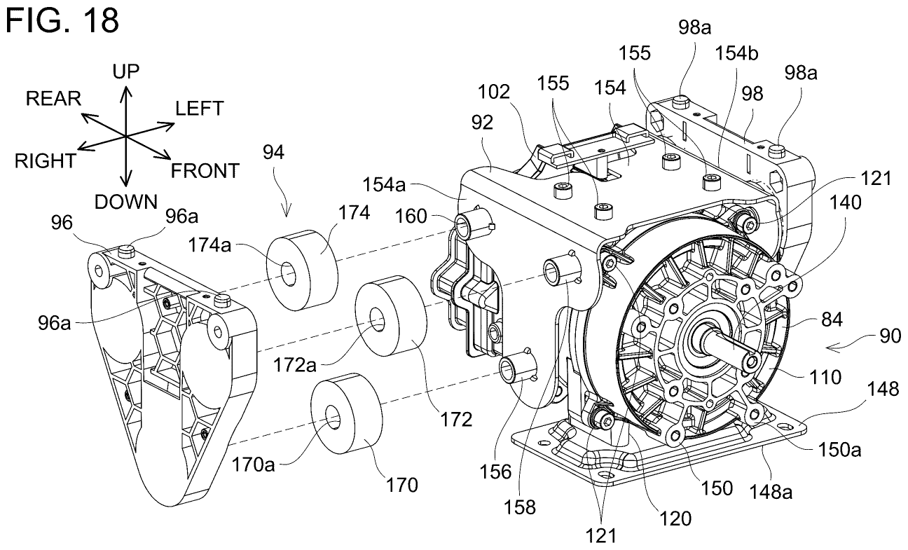

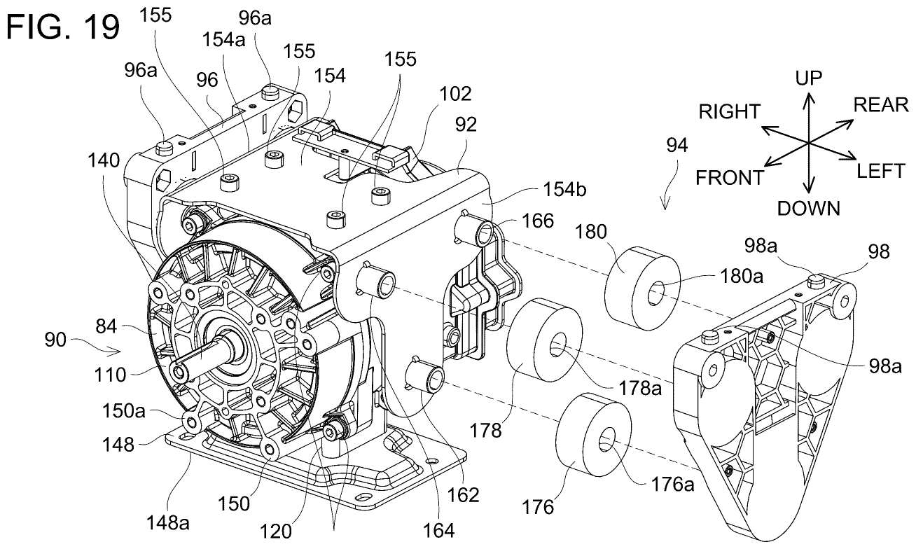

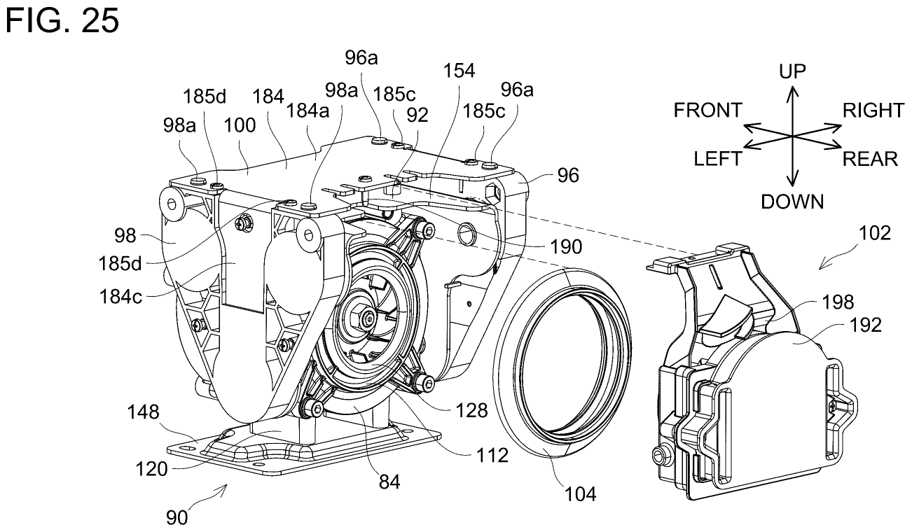

As shown in FIG. 12, motor unit 10 has the motor housing 84, the motor 86 (see FIG. 16), the fan 88 (see FIG. 16), a fixing unit 90, a plate member 92, a vibration-proof part 94 (see FIGS. 18 and 19), a right cover member 96, a left cover member 98, a support unit 100, a control unit 102 (see FIG. 25), and a tubular vibration-proof member 104 (see FIG. 25).

As shown in FIG. 13, the motor housing 84 is surrounded by the accommodating part 20. The accommodating part 20 is disposed outside of the motor housing 84. The motor housing 84 houses the motor 86 and the fan 88 therein. The motor housing 84 has a motor housing body 108, a front bracket 110, and a rear bracket 112.

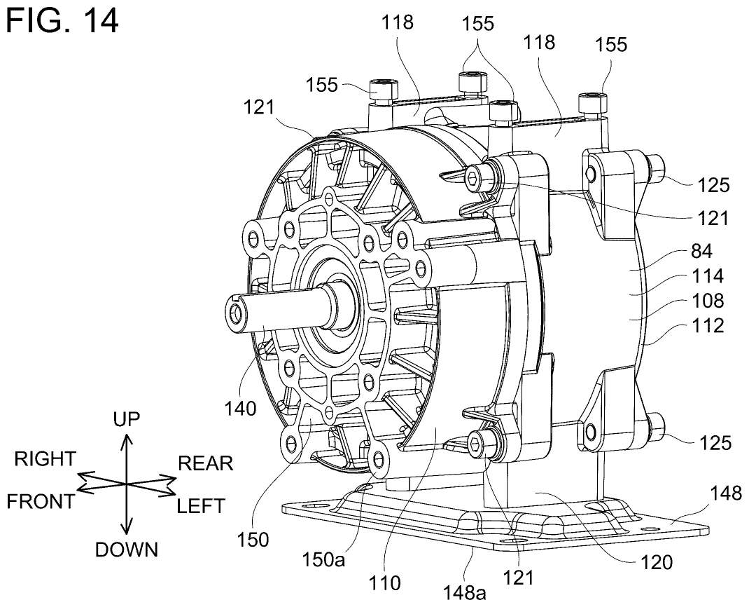

The motor housing body 108 has a tube portion 114, a bulkhead portion 116, a screw boss portion 118 (see FIG. 14), and a leg portion 120. The tube portion 114 has a cylindrical shape. The bulkhead portion 116 extends radially inward from an inner surface of the tube portion 114 toward a center of the tube portion 114. As shown in FIG. 14, the screw boss portion 118 protrudes upward from a top of the tube portion 114. The leg portion 120 protrudes downward from a bottom of the tube portion 114. As shown in FIG. 13, the leg portion 120 penetrates the second opening 28.

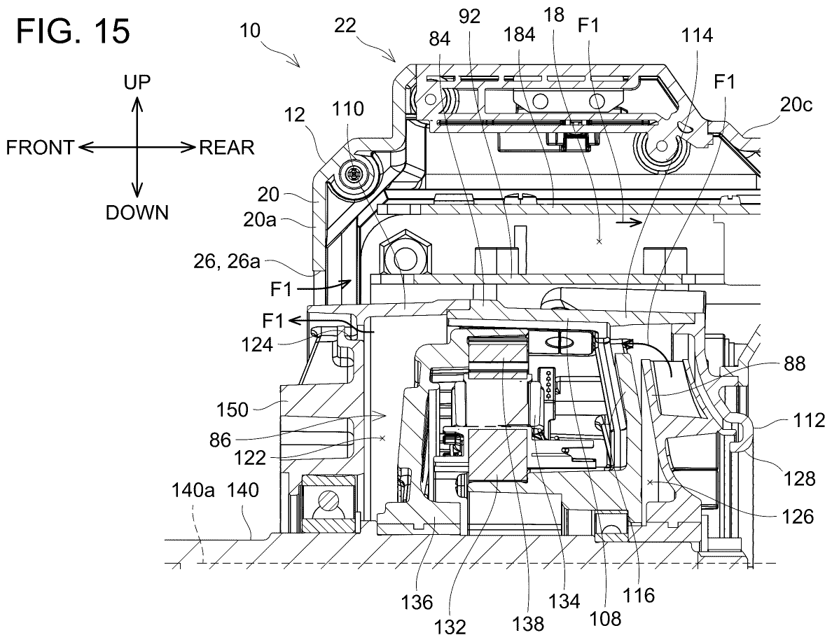

The front bracket 110 is fixed to a front end of the motor housing body 108 by screws 121 (see FIG. 14). A motor accommodating space 122 is defined by the front bracket 110, the tube portion 114, and a front surface of the bulkhead portion 116. The front bracket 110 penetrates the first opening 26 of the body housing 12. The front bracket 110 is separated away from an outer edge of the first opening 26. The front bracket 110 and the outer edge of the first opening 26 define an air intake port 26a. The air intake port 26a is a portion of the first opening 26. The air intake port 26a connects the accommodating space 18 of the body housing 12 to the outside of the body housing 12. As shown in FIG. 15, the front bracket 110 has an exhaust port 124. The exhaust port 124 penetrates the front bracket 110 in the front-rear direction. The exhaust port 124 connects the motor accommodating space 122 to the outside of the motor housing 84.

As shown in FIG. 16, the rear bracket 112 is fixed to a rear end of the motor housing body 108 by screws 125 (see FIG. 14). A fan accommodating space 126 is defined by the rear bracket 112, the tube portion 114, and a rear surface of the bulkhead portion 116. The rear bracket 112 has a motor intake port 128. The motor intake port 128 passes through the rear bracket 112 in the front-rear direction. The motor intake port 128 connects the fan accommodating space 126 to the outside of the motor housing 84.

The motor 86 is disposed in a motor accommodating space 122. The motor 86 is, for example, a DC motor. In a variant, the motor 86 may be an AC motor. The motor 86 is an outer rotor brushless motor. In a variant, the motor 86 may be an inner rotor brushless motor or a brushed motor. The motor 86 operates when the left portion of the operation switch 78a (see FIG. 7) is pushed into the body housing 12 when the motor unit 10 is in the on state. The motor 86 is operated by electric power supplied from the battery packs BP.

As shown in FIG. 5, a weight of motor 86 is equal to or more than 2 kg and equal to or less than 3 kg. A length of the motor 86 in the front-rear direction is equal to or more than 140 mm and equal to or less than 145 mm. A volume of the motor 86 is equal to or more than 650 cm³ and equal to or less than 750 cm³. A diameter of the motor 86 is equal to or more than 80 mm and equal to or less than or equal to 145 mm. As shown in FIG. 9, a maximum output value of the motor 86 is equal to or more than 1.5 kW and equal to or less than 4 kW. In a variant, the maximum output value of the motor 86 may be equal to or more than 1.5 kW and equal to or less than 3 kW, or equal to or more than 1.5 kW and equal to or less than 2.35 kW. A maximum current value of the motor 86 is equal to or more than 15 A and equal to or less than 70 A. A torque of the motor 86 is equal to or more than 2 Nm and equal to or less than 11 Nm. In a variant, the torque of the motor 86 may be equal to or more than 3 Nm and equal to or less than 8 Nm. A speed of the motor 86 is equal to or more than 3000 rpm and equal to or less than 4300 rpm.

As shown in FIG. 16, the motor 86 has a stator body 132, a coil 134, an outer rotor body 136, a plurality of permanent magnets 138, and a motor shaft 140. The coil 134 is wound around the stator body 132. The outer rotor body 136 is arranged to surround an outer circumference of the stator body 132. A diameter of the outer rotor body 136 is approximately the same as the diameter of the motor 86. Each permanent magnet 138 is fixed to the outer rotor body 136.

The motor shaft 140 is fixed to the outer rotor body 136. The motor shaft 140 extends along the placement surface P1 when the motor unit 10 is placed on the placement surface P1. The motor shaft 140 penetrates the stator body 132. The motor shaft 140 penetrates the bulkhead portion 116. The motor shaft 140 is rotatably supported by the bulkhead portion 116 via a bearing 142. The motor shaft 140 penetrates the front bracket 110. The motor shaft 140 is rotatably supported on the front bracket 110 via a bearing 144. The motor shaft 140 rotates around a central axis 140a.

The fan 88 is fixed to a rear end of the motor shaft 140. The fan 88 is disposed in the fan accommodating space 126. In the present embodiment, the fan 88 is a centrifugal fan. In a variant, the fan 88 may be an axial fan. The fan 88 rotates in unison with the motor shaft 140.

The fixing unit 90 has a first fixing part 148 and a second fixing part 150. The first fixing part 148 is fixed to a lower end of the leg portion 120 by screws 152. The first fixing part 148 has a first fixing surface 148a. The first fixing surface 148a corresponds to a lower surface of the first fixing part 148. The first fixing surface 148a is substantially parallel to the motor shaft 140. When the motor unit 10 is placed on the placement surface P1, the first fixing surface 148a contacts the placement surface P1. The first fixing surface 148a is fixed to the working unit 4 (see FIG. 3).

As shown in FIG. 13, the first fixing part 148 is disposed below the motor 86. The motor 86 is positioned between the first fixing part 148 and the first battery receptacle 22.

Further, the motor 86 is disposed between the first fixing part 148 and the second battery receptacle 24 (see FIG. 12).

As shown in FIG. 16, the second fixing part 150 is formed on the front bracket 110. The second fixing part 150 has a second fixing surface 150a. The second fixing surface 150a corresponds to a front surface of the second fixing part 150. When the motor unit 10 is placed on the placement surface P1, the second fixing surface 150a is perpendicular to the placement surface P1. The second fixing surface 150a is substantially perpendicular to the first fixing surface 148a. The second fixing surface 150a is substantially perpendicular to the motor shaft 140. The second fixing surface 150a is fixed to the working unit 4 (see FIG. 2). The type of the working unit 4 configured to be fixed to the second fixing surface 150a is different from the type of the working unit 4 configured to be fixed to the first fixing surface 148a.

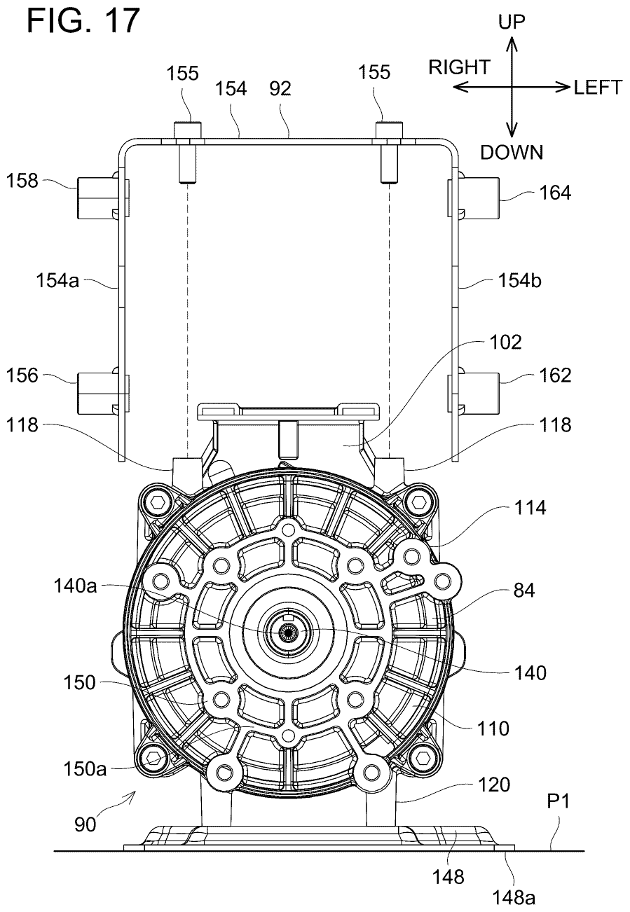

As shown in FIG. 17, the plate member 92 has a plate body 154. The plate body 154 is formed by bending a single plate. The plate body 154 has a substantially U-shape. The plate body 154 is fixed to the screw boss portion 118 by screws 155. The plate body 154 faces the top, a right portion, and a left portion of the tube portion 114.

As shown in FIGS. 18 and 19, the plate member 92 has a first right sleeve 156, a second right sleeve 158, a third right sleeve 160, a first left sleeve 162, a second left sleeve 164, and a third left sleeve 166. The first right sleeve 156 has a cylindrical shape. A shape of the second right sleeve 158, a shape of the third right sleeve 160, a shape of the first left sleeve 162, a shape of the second left sleeve 164, and a shape of the third left sleeve 166 are identical to the shape of the first right sleeve 156.

As shown in FIG. 18, the first right sleeve 156, the second right sleeve 158, and the third right sleeve 160 project rightward from a right wall 154a of the plate body 154. The first right sleeve 156 is disposed at a bottom of the right wall 154a. The second right sleeve 158 is disposed at a front upper portion of the right wall 154a. The third right sleeve 160 is disposed at a rear upper portion of the right wall 154a.

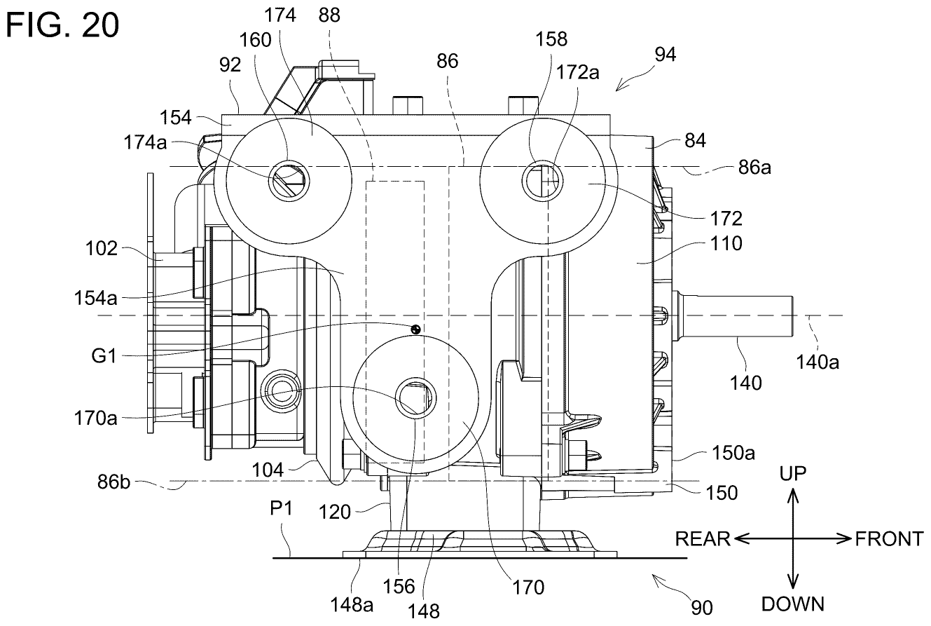

As shown in FIG. 20, the first right sleeve 156 is disposed below the central axis 140a of the motor shaft 140. The second right sleeve 158 and the third right sleeve 160 are positioned above the central axis 140a of the motor shaft 140. A position of the second right sleeve 158 in the up-down direction is identical to a position of the third right sleeve 160 in the up-down direction. With respect to the front-rear direction, the first right sleeve 156 is positioned in the center between the second right sleeve 158 and the third right sleeve 160. A distance between the first right sleeve 156 and the second right sleeve 158 is identical to a distance between the second right sleeve 158 and the third right sleeve 160 and to a distance between the third right sleeve 160 and the first right sleeve 156, respectively.

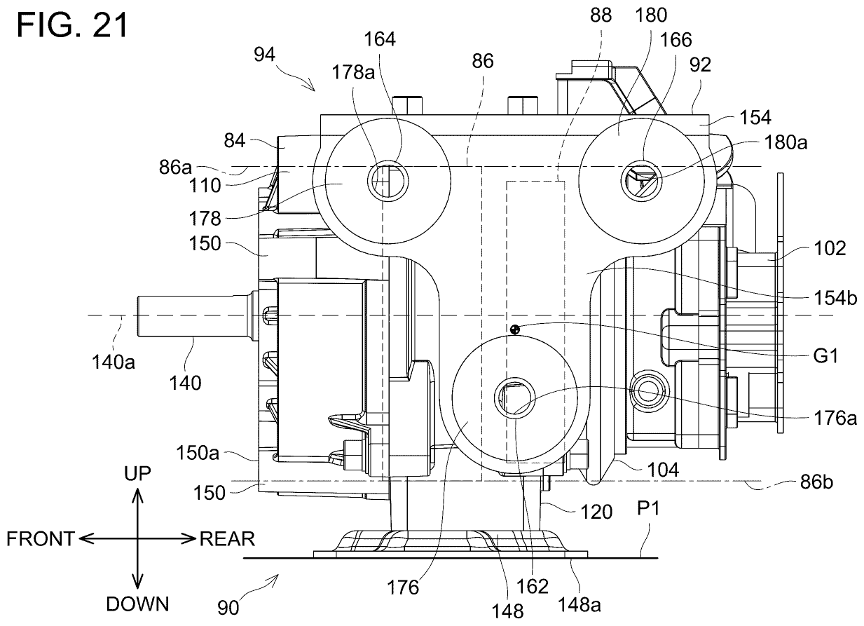

As shown in FIG. 19, the first left sleeve 162, the second left sleeve 164, and the third left sleeve 166 project leftward from a left wall 154b of the plate body 154. A position of the first left sleeve 162 in the up-down and front-rear directions is identical to a position of the first right sleeve 156 in the up-down and front-rear directions. A position of the second left sleeve 164 in the up-down and front-rear directions is identical to a position of the second right sleeve 158 in the up-down and front-rear directions. A position of the third left sleeve 166 in the up-down and front-rear directions is identical to a position of the third right sleeve 160 in the up-down and front-rear directions. As shown in FIG. 21, a distance between the first left sleeve 162 and the second left sleeve 164 is substantially identical to a distance between the second left sleeve 164 and the third left sleeve 166 and to a distance between the third left sleeve 166 and the first left sleeve 162, respectively. Further, the distance between the first left sleeve 162 and the second left sleeve 164 is substantially identical to a distance between the first right sleeve 156 (see FIG. 20) and the second right sleeve 158 (see FIG. 20).

As shown in FIGS. 18 and 19, the vibration-proof part 94 has a first right vibration-proof member 170, a second right vibration-proof member 172, a third right vibration-proof member 174, a first left vibration-proof member 176, a second left vibration-proof member 178, and a third left vibration-proof member 180. The first right vibration-proof member 170 has a cylindrical shape. The first right vibration-proof member 170 is constituted of an elastic material. The first right vibration-proof member 170 is constituted of, for example, a foam, a rubber material, a thermoplastic elastomer material, or a thermosetting elastomer material. Shapes of the second right vibration-proof member 172, the third right vibration-proof member 174, the first left vibration-proof member 176, the second left vibration-proof member 178, and the third left vibration-proof member 180 are the same as that of the first right vibration-proof member 170. Materials of the second right vibration-proof member 172, the third right vibration-proof member 174, the first left vibration-proof member 176, the second left vibration-proof member 178, the third left vibration-proof member 180 are the same as the material of the first right vibration-proof member 170.

As shown in FIG. 18, the first right sleeve 156 is inserted into an opening 170a of the first right vibration-proof member 170. The second right sleeve 158 is inserted into an opening 172a of the second right vibration-proof member 172. The third right sleeve 160 is inserted into an opening 174a of the third right vibration-proof member 174. The first right vibration-proof member 170 protrudes to the right of the first right sleeve 156 when in contact with the right wall 154a of the plate body 154. The second right vibration-proof member 172 protrudes to the right of the second right sleeve 158 when in contact with the right wall 154a of the plate body 154. The third right vibration-proof member 174 protrudes to the right of the third right sleeve 160 when in contact with the right wall 154a of the plate body 154. As shown in FIG. 20, the first right vibration-proof member 170 is positioned below a center of gravity G1 of the motor unit 10. The center of gravity G1 of the motor unit 10 is the center of gravity when the battery packs BP are not mounted. The second right vibration-proof member 172 and the third right vibration-proof member 174 are disposed above the center of gravity G1 of the motor unit 10. A distance between the first right vibration-proof member 170 and the second right vibration-proof member 172 is substantially identical to a distance between the second right vibration-proof member 172 and the third right vibration-proof member 174 and to a distance between the third right vibration-proof member 174 and the first right vibration-proof member 170, respectively. With respect to the front-rear direction, a center position of the first right vibration-proof member 170 is substantially identical to the position of the center of gravity G1 of the motor unit 10.

As shown in FIG. 19, the first left sleeve 162 is inserted into an opening 176a of the first left vibration-proof member 176. The first left vibration-proof member 176 is positioned below the center of gravity G1 of the motor unit 10. The second left sleeve 164 is inserted into an opening 178a of the second left vibration-proof member 178. The third left sleeve 166 is inserted into an opening 180a of the third left vibration-proof member 180. The second left vibration-proof member 178 and the third left vibration-proof member 180 are positioned above the center of gravity G1 of the motor unit 10. The first left vibration-proof member 176 protrudes to the left of the first left sleeve 162 when in contact with the left wall 154b of the plate body 154. The second left vibration-proof member 178 protrudes to the left of the second left sleeve 164 when in contact with the left wall 154b of the plate body 154. The third left vibration-proof member 180 protrudes to the left of the third left sleeve 166 when in contact with the left wall 154b of the plate body 154. As shown in FIG. 21, a distance between the first left vibration-proof member 176 and the second left vibration-proof member 178 is substantially identical to a distance between the second left vibration-proof member 178 and the third left vibration-proof member 180 and a distance between the third left vibration-proof member 180 and the first left vibration-proof member 176, respectively. Further, the distance between the first left vibration-proof member 176 and the second left vibration-proof member 178 is substantially identical to a distance between the first right vibration-proof member 170 (see FIG. 20) and the second right vibration-proof member 172 (see FIG. 20). With respect to the front-rear direction, a center position of the first left-vibration-proof member 176 is substantially identical to the position of the center of gravity G1 of the motor unit 10.

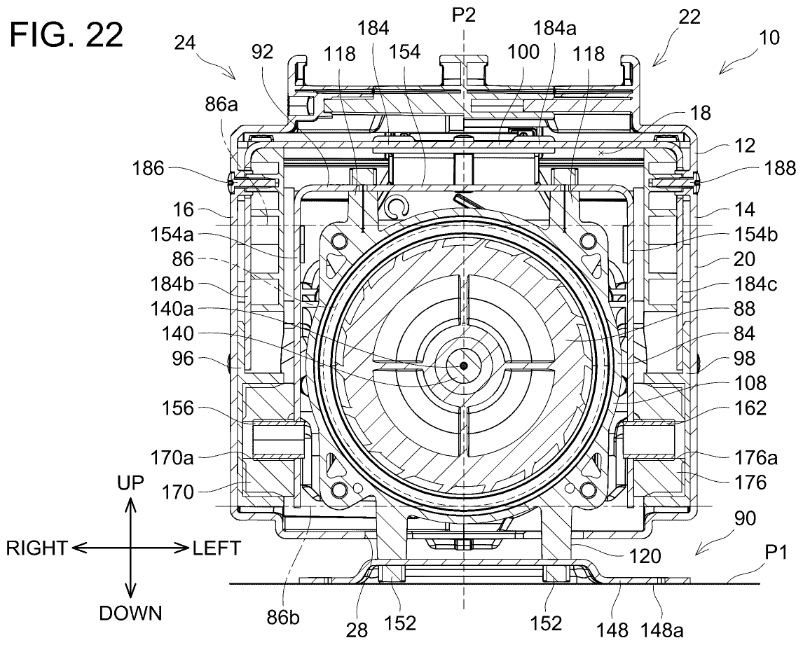

As shown in FIG. 22, when the motor unit 10 is placed on the placement surface P1, the first right vibration-proof member 170 and the first left vibration-proof member 176 are positioned below an upper end 86a of the motor 86. The upper end 86a of the motor 86 is substantially the same as an upper end of the outer rotor body 136. In FIGS. 20 through 23, a position of the upper end 86a of the motor 86 in the up-down direction is illustrated by a single dotted line. The first right vibration-proof member 170 and the first left vibration-proof member 176 are positioned below the central axis 140a of the motor shaft 140. The first right vibration-proof member 170 and the first left vibration-proof member 176 are disposed above a lower end 86b of the motor 86. The lower end 86b of the motor 86 is substantially the same as a lower end of the outer rotor body 136. In FIGS. 20 through 23, a position of the lower end 86b of the motor 86 in the up-down direction is illustrated by a single dotted line. The first right vibration-proof member 170 is disposed plane-symmetrical with the first left vibration-proof member 176 with respect to a perpendicular plane P2 perpendicular to the placement surface P1 and including the central axis 140a of the motor shaft 140 (i.e., front-rear direction). A distance between the first right vibration-proof member 170 and the perpendicular plane P2 is substantially identical to a distance between the first left vibration-proof member 176 and the perpendicular plane P2. When the motor unit 10 is viewed along the front-rear direction, the motor 86 and the fan 88 are positioned between the first right vibration-proof member 170 and the first left vibration-proof member 176. When the motor unit 10 is viewed along the left-right direction, each of the motor 86 and the fan 88 at least partially overlaps the first right vibration-proof member 170 and the first left vibration-proof member 176 (see FIG. 21).

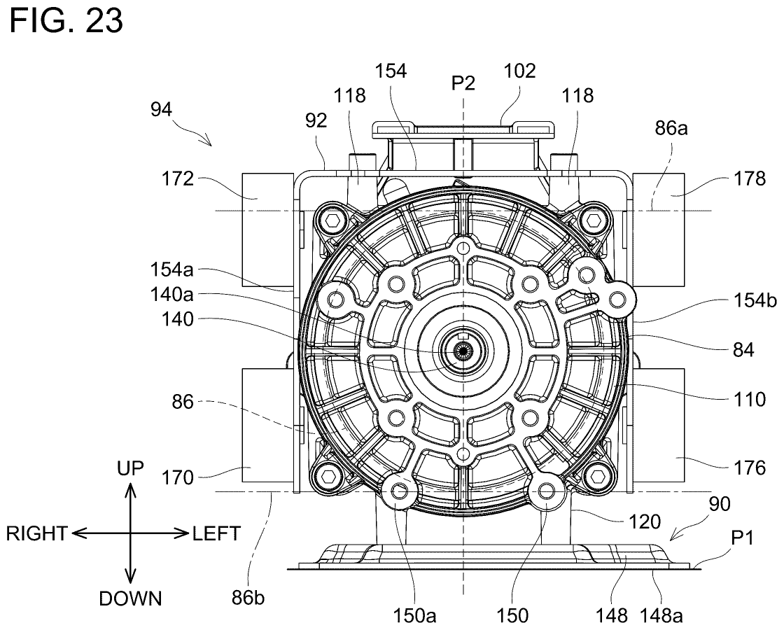

As shown in FIG. 23, when the motor unit 10 is placed on the placement surface P1, the second right vibration-proof member 172 and the second left vibration-proof member 178 are disposed above the lower end 86b of the motor 86. The second right vibration-proof member 172 and the second left vibration-proof member 178 are positioned above the lower end 86b of the motor 86. The second right vibration-proof member 172 and the second left vibration-proof member 178 are positioned above the central axis 140a of the motor shaft 140. A center of the second right vibration-proof member 172 in the up-down direction and a center of the second left vibration-proof member 178 in the up-down direction are disposed below the upper end 86a of the motor 86. An upper end of the second right vibration-proof member 172 and an upper end of the second left vibration-proof member 178 are disposed above the upper end 86a of the motor 86. The second right vibration-proof member 172 is positioned plane-symmetrical with the second left vibration-proof member 178 with respect to the perpendicular plane P2. A distance between the second right vibration-proof member 172 and the perpendicular plane P2 is substantially the same as a distance between the second left vibration-proof member 178 and the perpendicular plane P2. When the motor unit 10 is viewed along the front-rear direction, the motor 86 and the fan 88 (see FIG. 22) are disposed between the second right vibration-proof member 172 and the second left vibration-proof member 178. When the motor unit 10 is viewed along the front-rear direction, an entirety of the second right vibration-proof member 172 overlaps an entirety of the third right vibration-proof member 174 (see FIG. 20), and an entirety of the second left vibration-proof member 178 overlaps an entirety of the third left vibration-proof member 180 (see FIG. 21). With respect to the perpendicular plane P2, the third right vibration-proof member 174 is arranged in plane symmetry with the third left vibration-proof member 180. Further, when the motor unit 10 is viewed along the front-rear direction, the motor 86 and the fan 88 are positioned between the third right vibration-proof member 174 and the third left vibration-proof member 180.

When the motor unit 10 is viewed along the left-right direction, the motor 86 is positioned between the second right vibration-proof member 172 and the second left vibration-proof member 178 (see FIG. 21). Further as shown in FIG. 20, also the second right vibration-proof member 172 and the second left vibration-proof member 178 are disposed frontward of the fan 88. Moreover, the third right vibration-proof member 174 and the third left vibration-proof member 180 (see FIG. 21) are positioned rearward of the fan 88.

As shown in FIG. 18, the right cover member 96 is disposed on a right side of the right wall 154a of the plate body 154. The first right vibration-proof member 170, the second right vibration-proof member 172, and the third right vibration-proof member 174 are interposed between the right cover member 96 and the right wall 154a of the plate body 154. The right cover member 96 is attached to the plate body 154 via the first right vibration-proof member 170, the second right vibration-proof member 172, and the third right vibration-proof member 174. The right cover member 96 is not in contact with the plate member 92. As shown in FIG. 12, the right cover member 96 is positioned between the right body housing 14 and the right wall 154a of the plate body 154. The right cover member 96 is fixed to the right body housing 14 This suppresses the first right vibration-proof member 170 (see FIG. 18), the second right vibration-proof member 172 (see FIG. 18), and the third right vibration-proof member 174 (see FIG. 18) from being detached from the plate member 92.

As shown in FIG. 19, the left cover member 98 is disposed on the left side of the left wall 154b of the plate body 154. The first left vibration-proof member 176, the second left vibration-proof member 178, and the third left vibration-proof member 180 are interposed between the left cover member 98 and the left wall 154b of the plate body 154. The left cover member 98 is attached to the plate body 154 via the first left vibration-proof member 176, the second left vibration-proof member 178, and the third left vibration-proof member 180. The left cover member 98 is not in contact with the plate member 92. As shown in FIG. 12, the left cover member 98 is positioned between the left body housing 16 and the left wall 154b of the plate body 154. The left cover member 98 is fixed to the left body housing 16. This suppresses the first left vibration-proof member 176 (see FIG. 19), the second left vibration-proof member 178 (see FIG. 19), and the third left vibration-proof member 180 (see FIG. 19) from detaching from the plate member 92.

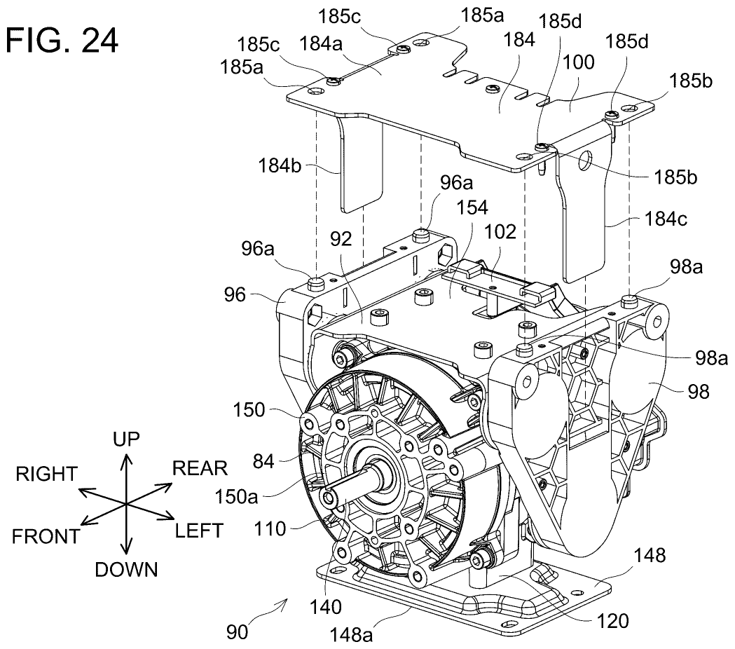

As shown in FIG. 24, the support unit 100 comprises a support plate 184. The support plate 184 is formed by bending a single plate. The support plate 184 has a substantially U-shape. The support plate 184 comprises an upper wall 184a facing an upper surface of the plate body 154 of the plate member 92, a right wall 184b facing a right surface of the right cover member 96, and a left wall 184c facing a left surface of the left cover member 98. The plate member 92, the right cover member 96, and the left cover member 98 are interposed between the right wall 184b and the left wall 184c.

The upper wall 184a has two right positioning holes 185a and two left positioning holes 185b. The right positioning holes 185a penetrate the upper wall 184a in the up-down direction. The right positioning holes 185a are disposed at a right end of the upper wall 184a. The two right positioning holes 185a are aligned in the front-rear direction. The left positioning holes 185b penetrate the upper wall 184a in the up-down direction. The left positioning holes 185b are disposed at a left end of the upper wall 184a. The two left positioning holes 185b are aligned in the front-rear direction.

The right cover member 96 comprises two right positioning projections 96a projecting upward, and the right positioning holes 185a receive these right positioning projections 96a. The left cover member 98 comprises two left positioning projections 98a projecting upward, and the left positioning holes 185b receive these left positioning projections 98a. Due to this, the support plate 184 is positioned relative to the right cover member 96 and the left cover member 98. The support plate 184 is fixed to the right cover member 96 by screws 185c. The support plate 184 is fixed to the left cover member 98 by screws 185d.

As shown in FIG. 22, the right wall 184b is interposed between the right surface of the right cover member 96 and the right body housing 14. The right wall 184b, the right cover member 96, and the right body housing 14 are fixed to each other with screws 186. The left wall 184c is interposed between the left surface of the left cover member 98 and the left body housing 16. The left wall 184c, the left cover member 98, and the left body housing 16 are fixed to each other with screws 188.

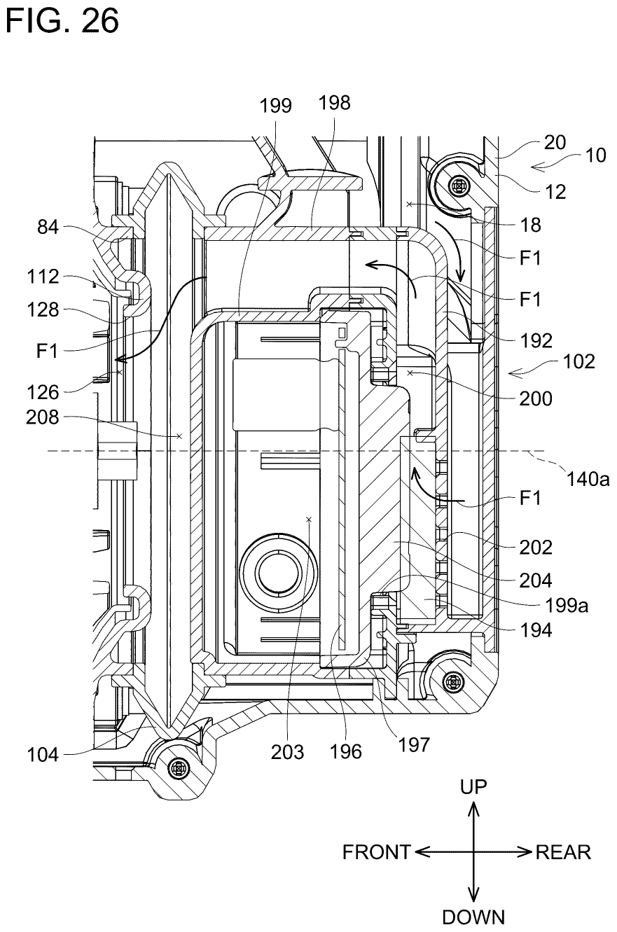

As shown in FIG. 25, the control unit 102 is disposed behind the motor housing 84. The control unit 102 is disposed inside the body housing 12 (see FIG. 4). The control unit 102 comprises a board housing 192, a filter member 194 (see FIG. 26), a control circuit board 196 (see FIG. 26), and a board case 197 (see FIG. 26). The board housing 192 comprises an outer housing part 198 and an inner housing part 199 (see FIG. 26). The outer housing part 198 defines an external shape of the control unit 102. The outer housing part 198 is fixed to a rear end of the support plate 184 by screws 190. As shown in FIG. 26, the outer housing part 198 has an interior space 200. Further, the outer housing part 198 has an intake port 202. The intake port 202 is disposed at a rear portion of the outer housing part 198. The intake port 202 connects the interior space 200 to the outside of the board housing 192.

The inner housing part 199 is disposed in the interior space 200. The inner housing part 199 is disposed in front of the intake port 202. The inner housing part 199 is fixed to the outer housing part 198. The inner housing part 199 has a board accommodating space 203 therein.

The filter member 194 is disposed in the interior space 200. The filter member 194 is disposed in front of the intake port 202. The filter member 194 blocks the intake port 202. The filter member 194 has fine vent holes (not shown) therein. The filter member 194 is constituted of, for example, filter material or foam material. Air flows through the filter member 194 through the vent holes. As the air flows through the vent holes, the filter member 194 removes dust and other foreign matters contained in the flowing air.

The control circuit board 196 is disposed in the board accommodating space 203. The control circuit board 196 has a microcontroller and a plurality of switching elements. The switching elements are, for example, IGBTs or MOSFETs. The switching elements are switched between an on state and an off state by being controlled by the microcontroller. The control circuit board 196 is arranged along a plane extending along the up-down and left-right directions. The control circuit board 196 is disposed in front of the intake port 202. The control circuit board 196 is disposed behind the motor intake port 128 on the rear bracket 112. The control circuit board 196 controls the motor 86 (see FIG. 13). As shown in FIG. 13, the control circuit board 196 is disposed on the central axis 140a of the motor shaft 140. The control circuit board 196 is disposed behind the fan 88. When the motor unit 10 is viewed along the front-rear direction, the control circuit board 196 at least partially overlaps each of the motor 86 and the fan 88. The motor 86, the fan 88, and the control circuit board 196 are aligned along the front-rear direction.

As shown in FIG. 26, the board case 197 is disposed in the board accommodating space 203. The board case 197 is disposed in front of the intake port 202. The board case 197 is positioned between the control circuit board 196 and the intake port 202. The board case 197 supports the control circuit board 196. The control circuit board 196 is disposed inside the board case 197. The board case 197 is fixed to the inner housing part 199. The board case 197 comprises heat dissipating fins 204. The heat dissipating fins 204 have a flat plate shape extending in the up-down and front-rear directions. The inner housing part 199 has a through hole 199a penetrating a rear end of the inner housing part 199, and the heat dissipating fins 204 pass through the through hole 199a. The heat dissipating fins 204 face the intake port 202 in the front-rear direction.

The tubular vibration-proof member 104 is disposed in front of the board housing 192 and behind the rear bracket 112. The tubular vibration-proof member 104 is constituted of an elastic material. A material of the tubular vibration-proof member 104 is the same as the material of the first right vibration-proof member 170 (see FIG. 18). The tubular vibration-proof member 104 has a tubular shape. The tubular shape includes a bellows shape having a circular cross section. The tubular vibration-proof member 104 has an air passage 208 therein. The tubular vibration-proof member 104 is fixed to each of a front end of the board housing 192 and a rear end of the rear bracket 112. The front end of the board housing 192 is open and the tubular vibration-proof member 104 encloses the front end of the board housing 192. The air passage 208 is connected to the interior space 200 through the front end of the board housing 192. The tubular vibration-proof member 104 encloses the motor intake port 128 of the rear bracket 112. The air passage 208 is connected to the fan accommodating space 126 via the motor intake port 128. As shown in FIG. 13, when the motor unit 10 is viewed along the front-rear direction, the air passage 208 at least partially overlaps each of the motor 86 and the fan 88.

When the control circuit board 196 controls the motor 86 to operate, the motor shaft 140 rotates, and the fan 88 rotates. As shown in FIG. 15, air flows through the air intake port 26a and into the accommodating space 18 of the body housing 12 from outside the motor unit 10. In the drawing, the air flow is indicated by an arrow line with a sign F1. The inflow air flows rearward between the motor housing 84 and the plate member 92, between the plate member 92 and the support plate 184, and between the support plate 184 and the upper wall 20c of the body housing 12.

As shown in FIG. 26, air flows around the outer housing part 198, then passes through the intake port 202 and flows into the interior space 200. The inflowing air passes through the filter member 194 and flows upward between the outer housing part 198 and inner housing part 199 along the heat dissipating fins 204. As the air passes through the filter member 194, foreign matters contained in the flowing air are removed. Further, the control circuit board 196 is cooled as the air flows along the heat dissipating fins 204. The air then flows frontward between the outer housing part 198 and inner housing part 199, through the air passage 208 of the tubular vibration-proof member 104 and the motor intake port 128 of the rear bracket 112, and flows from the interior space 200 into the fan accommodating space 126.

As shown in FIG. 15, the air flowing into the fan accommodating space 126 is sent by the fan 88 in a direction separating away from the central axis 140a (outward in a radial direction of the fan 88). The air then flows from the fan accommodating space 126 into the motor accommodating space 122. The air flowing into the motor accommodating space 122 flows frontward inside and outside the motor 86. This cools the motor 86. The air then passes through the exhaust port 124 of the front bracket 110 and is discharged from the motor accommodating space 122 to the outside of the motor unit 10.

As shown in FIGS. 2, 3, and 27 to 33, the motor unit 10 can be applied to multiple types of working units 4. In FIGS. 2, 3, and 27 to 33, the coordinate system is changed to a coordinate system different from the coordinate system for the motor unit 10 described above. Specifically, a direction perpendicular to the placement surface P1 may be termed the up-down direction, a direction perpendicular to the up-down direction may be termed the front-rear direction, and a direction perpendicular to the up-down and front-rear directions may be termed the left-right direction.

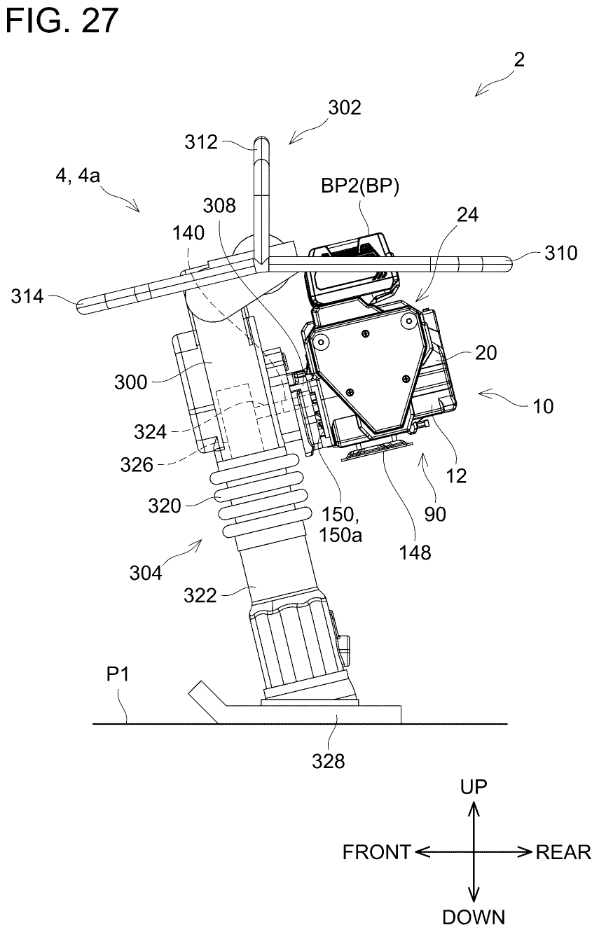

As shown in FIG. 27, motor unit 10 is configured to be attached to a rammer 4a. The rammer 4a is a ground consolidator that consolidates the ground. The rammer 4a comprises an upper housing 300, a handle unit 302, and a work part 304. The upper housing 300 comprises a fixing platform 308 disposed at a rear upper portion thereof. The fixing platform 308 is fixed to the second fixing surface 150a of the motor unit 10.

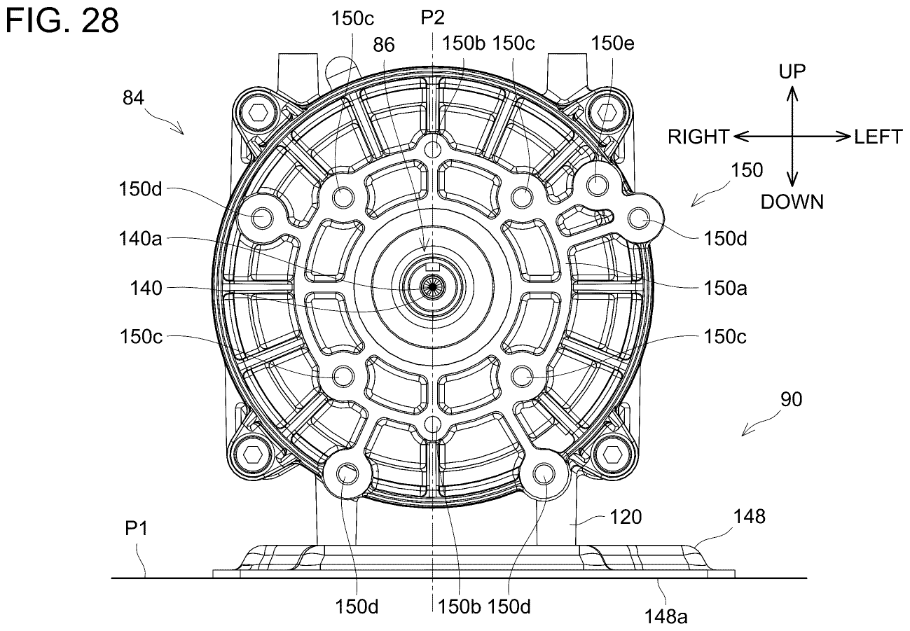

Before describing a detailed configuration of the fixing platform 308, a detailed configuration of the second fixing part 150 of the motor unit 10 is described. As shown in FIG. 28, the second fixing part 150 has two positioning holes 150b, four first fixing holes 150c, four second fixing holes 150d, and an auxiliary hole 150e. The positioning holes 150b, the first fixing holes 150c, the second fixing holes 150d, and the auxiliary hole 150e are defined in the second fixing surface 150a. Arrangement of the two positioning holes 150b, the four first fixing holes 150c, the four second fixing holes 150d, and the auxiliary hole 150e is same as arrangement of a plurality of holes in an engine unit configured to be attached to the rammer 4a. Therefore, the motor unit 10 can be used by fixing the second fixing part 150 to the working unit 4, to which the engine unit can be attached.

Each of the two positioning holes 150b is spaced apart from the central axis 140a of the motor shaft 140 by a certain distance. The two positioning holes 150b are arranged 180 degrees apart around the central axis 140a. The two positioning holes 150b are arranged on the perpendicular plane P2.

Each of the four first fixing holes 150c is separated from the central axis 140a by a certain distance. The four first fixing holes 150c are arranged at intervals of 90 degrees around the central axis 140a. A distance between the first fixing holes 150c and the central axis 140a is slightly shorter than a distance between the positioning holes 150b and the central axis 140a. Two of the first fixing holes 150c are disposed to the right of the perpendicular plane P2 and the remaining two first fixing holes 150c are disposed to the left of the perpendicular plane P2.

Each of the four second fixing holes 150d is separated from the central axis 140a by a certain distance. A distance between the second fixing holes 150d and the central axis 140a is longer than a distance between the positioning holes 150b and the central axis 140a. Two of the second fixing holes 150d are disposed to the right of the perpendicular plane P2 and the remaining two second fixing holes 150d are disposed to the left of the perpendicular plane P2. The auxiliary hole 150e is slightly farther away from the central axis 140a than the second fixing holes 150d.

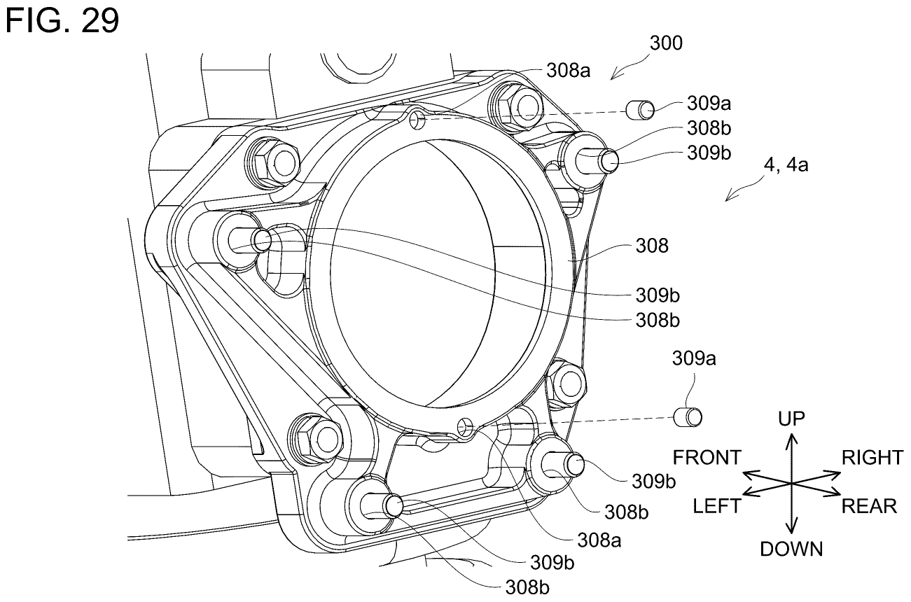

As shown in FIG. 29, the fixing platform 308 has two positioning holes 308a and four fixing holes 308b. Arrangement of the two positioning holes 308a and four fixing holes 308b is identical to arrangement of the two positioning holes 150b and four second fixing holes 150d in the second fixing part 150.

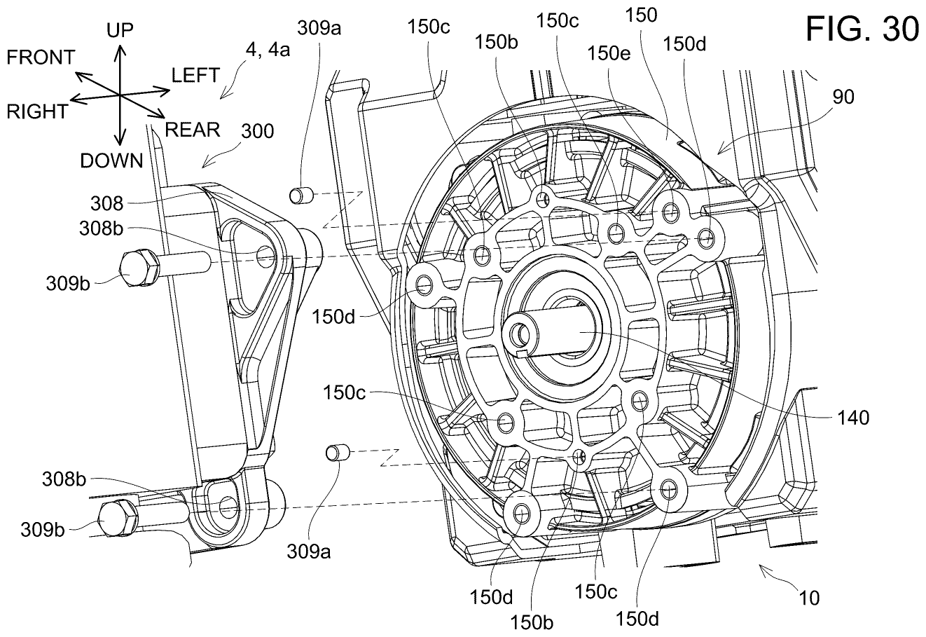

As shown in FIGS. 29 and 30, when fixing the second fixing part 150 to the fixing platform 308, firstly, each of two positioning pins 309a is inserted into a corresponding one of the positioning holes 308a and into a corresponding one of the positioning holes 150b. This positions the second fixing part 150 with respect to the fixing platform 308. As a result, the fixing holes 308b face the second fixing holes 150d. Next, each of four screws 309b is inserted into a corresponding one of the fixing holes 308b and screwed into a corresponding one of the second fixing holes 150d. As a result, the second fixing part 150 is fixed to the fixing platform 308 with the second fixing part 150 positioned with respect to the fixing platform 308. When the second fixing part 150 is fixed to the fixing platform 308, the motor shaft 140 of the motor unit 10 protrudes from the body housing 12 toward a lower front side.

As shown in FIG. 2, the handle unit 302 comprises a first handle 310, a second handle 312, and a third handle 314. The first handle 310 extends rearward from an upper end of the upper housing 300, then bends to extend rightward, and further bends to extend frontward. The first handle 310 encloses the motor unit 10. The second handle 312 extends upward from the upper end of the upper housing 300, then bends to extend rightward, then further bends to extend downward. The third handle 314 extends frontward and downward from the upper end of the upper housing 300, then bends to extend rightward, and further bends to extend rearward and upward. The first handle 310, the second handle 312, and the third handle 314 are integrally formed. At least one of the first handle 310, the second handle 312, and the third handle 314 is grasped by the user during operation.

As shown in FIG. 27, the work part 304 has a bellows part 320, a rammer part 322, a shaft receiving part 324, and a drive part 326. The bellows part 320 is fixed to a lower portion of the upper housing 300. The bellows part 320 is extendable and retractable. The rammer part 322 is disposed at a bottom of the upper housing 300. An upper portion of the rammer part 322 is surrounded by the bellows part 320. The rammer part 322 is fixed to the bellows part 320. The rammer part 322 comprises a rammer plate 328 disposed at a lower end of the rammer part 322. The rammer plate 328 is in surface contact with the placement surface P1.

The shaft receiving part 324 and the drive part 326 are disposed inside the upper housing 300. The shaft receiving part 324 is fixed to the motor shaft 140 of the motor unit 10. The drive part 326 is fixed to the shaft receiving part 324. The drive part 326 operates the rammer part 322 when the motor shaft 140 rotates. Due to this, a detaching motion that moves the rammer part 322 away from the placement surface P1 and an approaching motion that moves the rammer part 322 closer to the placement surface P1 are repeatedly executed. The rammer plate 328 is repeatedly pressed against the placement surface P1, thereby hardening the placement surface P1, such as the ground.

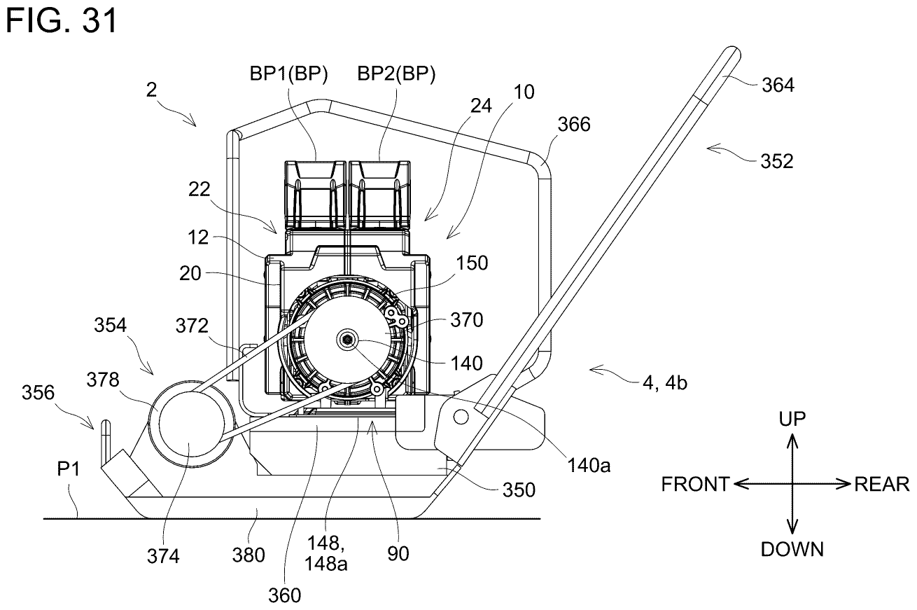

As shown in FIG. 31, the motor unit 10 can be attached to the plate compactor 4b. The plate compactor 4b is a ground consolidator that consolidates the ground. Force with which the plate compactor 4b consolidates the ground is less than force with which the rammer 4a consolidates the ground. The plate compactor 4b comprises a base 350, a handle unit 352, a transmission device 354, and a working part 356.

The base 350 has a fixing platform 360. The fixing platform 360 is fixed to the first fixing surface 148a of the motor unit 10.

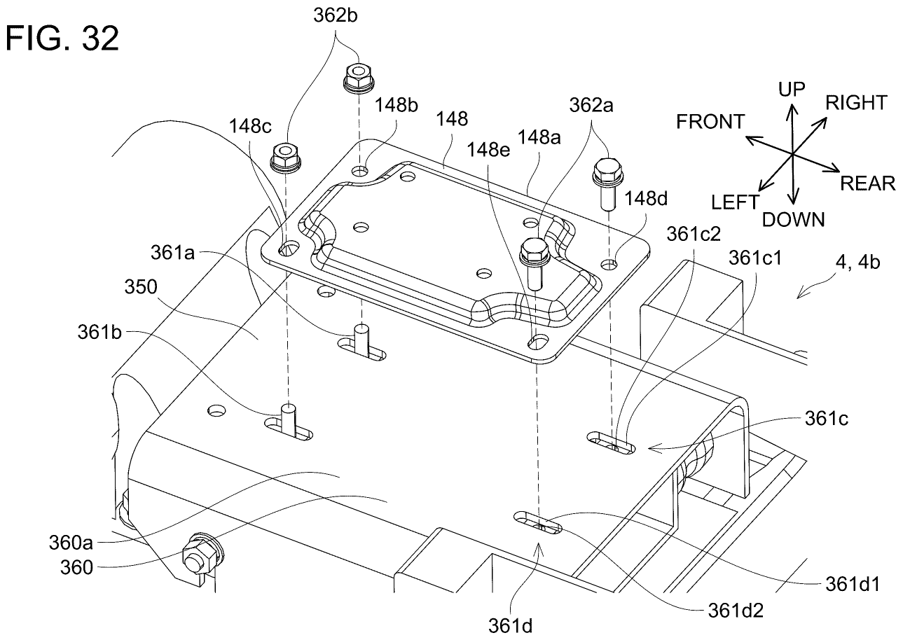

Before describing a detailed configuration of the fixing platform 360, a detailed configuration of the first fixing part 148 of the motor unit 10 is described. As shown in FIG. 32, the first fixing part 148 has a first positioning hole 148b, a second positioning hole 148c, a first fixing hole 148d, and a second fixing hole 148e. The first positioning hole 148b, the second positioning hole 148c, the first fixing hole 148d, and the second fixing hole 148e are disposed in the first fixing surface 148a. The first positioning hole 148b, the second positioning hole 148c, the first fixing hole 148d, and the second fixing hole 148e penetrate the first fixing part 148 in the up-down direction. Arrangement of the first positioning hole 148b, the second positioning hole 148c, the first fixing hole 148d, and the second fixing hole 148e is the same as arrangement of holes in an engine unit configured to be attached to the plate compactor 4b. Further, a distance between the first fixing surface 148a and the central axis 140a of the motor shaft 140 (see FIG. 28) is the same as a distance between a fixing surface of the engine unit and a shaft of the engine. Therefore, the motor unit 10 can be used by fixing the first fixing part 148 to the working unit 4 on which the engine unit is configured to be mounted.

The first and second positioning holes 148b and 148c are disposed at a front end of the first fixing part 148. The first positioning hole 148b and the second positioning hole 148c are aligned in the left-right direction. The first positioning hole 148b is a round hole. The second positioning hole 148c is a long hole extending in the left-right direction.

The first and second fixing holes 148d and 148e are disposed at a rear end of the first fixing part 148. The first fixing hole 148d and the second fixing hole 148e are aligned in the left-right direction. The first fixing hole 148d and the first positioning hole 148b are aligned in the front-rear direction. A shape of the first fixing hole 148d is substantially identical to that of the first positioning hole 148b. The second fixing hole 148e and the second positioning hole 148c are aligned in the front-rear direction. A shape of the second fixing hole 148e is substantially identical to that of the second positioning hole 148c.

The fixing platform 360 has a first positioning projection 361a, a second positioning projection 361b, a first fixing hole 361c, and a second fixing hole 361d. The first and second positioning protrusions 361a and 361b project upward from an upper surface 360a of the fixing platform 360. The first and second positioning protrusions 361a and 361b have a cylindrical shape. The first and second positioning protrusions 361a and 361b are aligned in the left-right direction.

The first fixing hole 361c and the second fixing hole 361d are aligned in the left-right direction. The first fixing hole 361c and the first positioning projection 361a are aligned in the front-rear direction. The second fixing holes 361d and the second positioning projection 361b are aligned in the front-rear direction.

The first fixing hole 361c comprises a first long hole part 361c1 extending in the front-rear direction and a first round hole part 361c2 disposed at a lower end of the first long hole part 361c1. The second fixing hole 361d has a second long hole part 361d1 extending in the front-rear direction and a second round hole part 361d2 disposed at a lower end of the second long hole part 361d1.

When fixing the first fixing part 148 to the fixing platform 360, firstly the first positioning projection 361a is inserted into the first positioning hole 148b and the second positioning projection 361b is inserted into the second positioning hole 148c. Due to this, the first fixing part 148 is positioned with respect to the fixing platform 360. Further, since the second positioning hole 148c is a long hole, the first fixing part 148 can be positioned with respect to the fixing platform 360 even when a distance between the first positioning projection 361a and the second positioning projection 361b varies from product to product. Next, a screw 362a is inserted into the first fixing hole 361c and the first long hole part 361c1 from above the first fixing part 148 and screwed with the first round hole part 361c2. Next, the screw 362a is inserted into the second fixing hole 361d and the second long hole part 361d1 from above the first fixing part 148 and screwed with the second round hole part 361d2. Then, each of two nuts 362b is screwed onto the first positioning projection 361a and the second positioning projection 361b. Due to this, the first fixing part 148 is fixed to the upper surface 360a of the fixing platform 360 with the first fixing part 148 positioned with respect to the fixing platform 360. When the first fixing part 148 is fixed to the fixing platform 360, the motor shaft 140 of the motor unit 10 extends in the left-right direction.

As shown in FIG. 3, the handle unit 352 comprises a first handle 364 and a second handle 366. The first handle 364 extends from a rear end of the base 350 rearward and upward, then bends to extend rightward and further bends to extend frontward and downward. The first handle 364 is disposed behind the motor unit 10. The first handle 364 is configured to be grasped by the user during operation.

The second handle 366 extends upward from the rear end of the base 350, then bends to extend frontward and upward, then further bends to extend frontward, then further bends to extend downward. The second handle 366 is arranged to surround the motor unit 10. The second handle 366 is configured to be grasped by the user, for example, when the plate compactor 4b is to be lifted.

As shown in FIG. 31, the transmission device 354 has a first pulley 370, a belt 372, and a second pulley 374. The first pulley 370 is fixed to the motor shaft 140. The belt 372 is strapped on the first pulley 370 and the second pulley 374. The second pulley 374 is positioned forward of the first pulley 370.

The working part 356 comprises an exciter 378 and a rammer plate 380. The exciter 378 is fixed to the second pulley 374. The exciter 378 allows the rammer plate 380 to operate when the second pulley 374 rotates. Due to this, the rammer plate 380 moves in the up-down direction. As the rammer plate 380 is repeatedly pressed against the placement surface P1, the placement surface P1, such as the ground, is hardened.

When the rammer 4a (see FIG. 27) or the plate compactor 4b is operated, the rammer 4a or the plate compactor 4b vibrates. This causes the vibration of the rammer 4a or the plate compactor 4b to be transmitted to the motor unit 10 via the motor shaft 140. As shown in FIG. 22, the vibration transmitted to the motor shaft 140 is transmitted from the motor 86 to the motor housing 84. The vibration is then transmitted from the motor housing 84 to the plate member 92 and then to the vibration-proof part 94. Once the vibration is transmitted to the vibration-proof part 94, the first right vibration-proof member 170, the second right vibration-proof member 172 (see FIG. 18), and the third right vibration-proof member 174 (see FIG. 18) deform elastically in the up-down, left-right, and front-rear directions between the right wall 154a of the plate member 92 and the right cover member 96, and the first left vibration-proof member 176, the second left vibration-proof member 178 (see FIG. 18), and the third left vibration-proof member 180 (see FIG. 18) deform elastically in the up-down, left-right, and front-rear directions between the left wall 154b of the plate member 92 and the left cover member 98. Due to this, the vibration is damped and the transmission of the vibration to the right cover member 96 and the left cover member 98 is suppressed. Thus, the vibration is suppressed from being transmitted to the battery packs BP (see FIG. 4) via the body housing 12, and the vibration is suppressed from being transmitted to the control circuit board 196 (see FIG. 26) of the control unit 102 via the support unit 100.

Further, as shown in FIG. 26, the vibration transmitted to the motor housing 84 is transmitted to the tubular vibration-proof member 104. When the vibration is transmitted to the tubular vibration-proof member 104, the tubular vibration-proof member 104 elastically deforms between the motor housing 84 and the board housing 192 in the up-down, left-right, and front-rear directions. This dampens the vibration and suppresses its transmission to the board housing 192. Thus, the vibration is suppressed from being transmitted to the control circuit board 196.

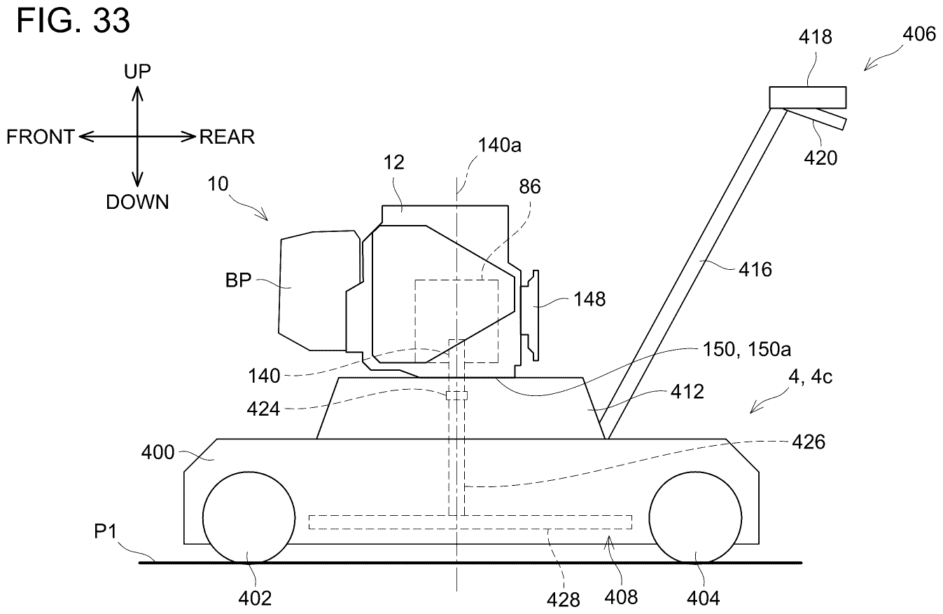

As shown in FIG. 33, the motor unit 10 is configured to be attached to a slope mower 4c. The slope mower 4c is a device configured to cut grass. The slope mower 4c comprises a housing 400, a pair of front wheels 402, a pair of rear wheels 404, a handle unit 406, and a work part 408. The housing 400 comprises a fixing platform 412 disposed at the top. The fixing platform 412 is fixed to the second fixing surface 150a of the motor unit 10. The motor shaft 140 of the motor unit 10 protrudes downward from the body housing 12.

The pair of front wheels 402 is rotatably supported onto a front portion of housing 400. The pair of rear wheels 404 is rotatably supported onto a rear portion of the housing 400. As the pair of front wheels 402 and the pair of rear wheels 404 rotate, the slope mower 4c moves on the placement surface P1.

The handle unit 406 comprises a fixed frame 416, a handle 418, and a trigger 420. The fixed frame 416 has a substantially U-shape. Both ends of the fixed frame 416 in its longitudinal direction are fixed to the housing 400.

The handle 418 is attached to a top of the fixed frame 416. The user moves the slope mower 4C by grasping the handle 418 and pushing it frontward.

The trigger 420 is pivotably attached to the handle 418. The trigger 420 is operated by a user's hand grasping the handle 418 to move it closer to the handle 418. When the trigger 420 is operated, the motor 86 of the motor unit 10 is activated.

The work part 408 comprises a coupling 424, a transmission shaft 426, and a blade 428. The coupling 424 connects the motor shaft 140 and the transmission shaft 426.

The transmission shaft 426 extends in the up-down direction. The transmission shaft 426 rotates around the central axis 140a, which extends in the up-down direction integrally with the motor shaft 140.

The blade 428 is fixed to a lower end of transmission shaft 426. The blade 428 rotates around the central axis 140a in unison with the transmission shaft 426. Due to this, the grass is cut.

### Effects

The motor unit 10 in the present embodiment is configured to be detachably attached to the working unit 4 to drive the working unit 4. The motor unit 10 comprises the motor 86 comprising the motor shaft 140 extending in the front-rear direction (example of first direction) and configured to drive the working unit 4, the control circuit board 196 configured to drive the motor 86, the motor housing 84 supporting the motor 86, the body housing 12 disposed on the outer side of the control circuit board 196 and the motor housing 84, the first fixing part 148 configured to be fixed to the working unit 4, the first right vibration-proof member 170 (example of first vibration-proof member) disposed between the body housing 12 and the motor housing 84, and the first left vibration-proof member 176 (example of second vibration-proof member) disposed between the body housing 12 and the motor housing 84. The first fixing part 148 is configured to be placed on the placement surface P1 when the motor unit 10 is placed on the placement surface P1, the first fixing part 148 being disposed substantially parallel to the motor shaft 140. In the up-down direction perpendicular to the placement surface P1, at least a part of the first right vibration-proof member 170 and at least a part of the first left vibration-proof member 176 are disposed below the upper end of the motor 86 when the motor unit 10 is placed on the placement surface P1. When the motor unit 10 is viewed along the front-rear direction, the motor 86 is disposed between the first right vibration-proof member 170 and the first left vibration-proof member 176.

According to the above configuration, at least a part of the first right vibration-proof member 170 and at least a part of the first left vibration-proof member 176 are disposed below the upper end of the motor 86, and the first right vibration-proof member 170 and the first left vibration-proof member 176 are disposed with the motor 86 in between them. Due to this, the first right vibration-proof member 170 and the first left vibration-proof member 176 are symmetrically disposed with respect to the motor 86. This allows the vibration of the motor 86 to be sufficiently damped.

The motor shaft 140 extends along the placement surface P1 when the motor unit 10 is placed on the placement surface P1. The first right vibration-proof member 170 and the first left vibration-proof member 176 are disposed below the central axis 140a of the motor shaft 140 when the motor unit 10 is placed on the placement surface P1.

Generally, the component(s) of the motor unit 10 are often disposed in the space above the upper end of the motor 86. According to the above configuration, available space below the central axis 140a of the motor shaft 140 can be used.

Further, the first right vibration-proof member 170 and the first left vibration-proof member 176 are disposed above the lower end of the motor 86 when the motor unit 10 is placed on the placement surface P1.

According to the above configuration, the available space between the central axis 140a of the motor shaft 140 and the lower end of the motor 86 can be used.

Further, the first right vibration-proof member 170 is the first distance away from the perpendicular plane P2 perpendicular to the placement surface P1 and including the front-rear direction. The first left vibration-proof member 176 is the first distance away from the perpendicular plane P2.

According to the above configuration, the distance between the first right vibration-proof member 170 and the perpendicular plane P2 is the same as the distance between the first left vibration-proof member 176 and the perpendicular plane P2. Therefore, the first right vibration-proof member 170 and the first left vibration-proof member 176 are symmetrically arranged with respect to the perpendicular plane P2. This allows the vibration of the motor 86 to be damped more.

The position of the center of gravity G1 of the motor unit 10 in the front-rear direction is substantially same as each of the center position of the first right vibration-proof member 170 in the front-rear direction and the center position of the first left vibration-proof member 176 in the front-rear direction.

According to the above configuration, the vibration of the motor 86 can be damped more.

The motor unit 10 further comprises the second right vibration-proof member 172 (example of third vibration-proof member) disposed between the body housing 12 and the motor housing 84, and the second left vibration-proof member 178 (example of fourth vibration-proof member) disposed between the body housing 12 and the motor housing 84. At least a part of the second right vibration-proof member 172 and at least a part of the second left vibration-proof member 178 are disposed above the central axis 140a of the motor shaft 140 when the motor unit 10 is placed on the placement surface P1. When the motor unit 10 is viewed along the front-rear direction, the motor 86 is disposed between the second right vibration-proof member 172 and the second left vibration-proof member 178.

According to the above configuration, the vibration of the motor 86 can be damped more as compared to a configuration in which the motor unit 10 has only the first right vibration-proof member 170 and the first left vibration-proof member 176.

The second right vibration-proof member 172 is disposed on the same side as the first right vibration-proof member 170 relative to the perpendicular plane P2 perpendicular to the placement surface P1 and including the front-rear direction. The second left vibration-proof member 178 is disposed on the same side as the first left vibration-proof member 176 relative to the perpendicular plane P2. The distance between the first right vibration-proof member 170 and the second right vibration-proof member 172 is substantially the same as the distance between the first left vibration-proof member 176 and the second left vibration-proof member 178.

According to the above configuration, the second right vibration-proof member 172 and the second left vibration-proof member 178 are symmetrically arranged with respect to the perpendicular plane P2. This allows the vibration of the motor 86 to be damped more.

Further, the motor unit 10 further comprises the plate member 92 fixed to the motor housing 84. The first right vibration-proof member 170 and the first left vibration-proof member 176 are fixed to the plate member 92 and the body housing 12.

In a configuration in which the first right vibration-proof member 170 and the first left vibration-proof member 176 are directly fixed to the motor housing 84, the configuration of the motor housing 84 becomes complicated. According to the above configuration, the configuration of the motor housing 84 can be suppressed from becoming complicated.

The motor unit 10 further comprises the second fixing part 150 configured to be fixed to a working unit 4 of a type different from the working unit 4 fixed to the first fixing part 148.

According to the above configuration, the types of working units 4 configured to use the motor unit 10 can be increased.

The motor unit 10 further comprises the fan 88 fixed to the motor 86, the board housing 192 supporting the control circuit board 196, and the tubular vibration-proof member 104 disposed between the motor housing 84 and the board housing 192 and having a tubular shape. When the fan 88 rotates, the air cools the control circuit board 196 and passes inside the tubular vibration-proof member 104.

According to the above configuration, when the motor 86 vibrates, the tubular vibration-proof member 104 dampens the vibration of the motor 86. In addition, the air that cools the control circuit board 196 passes inside the tubular vibration-proof member 104. By using the tubular vibration-proof member 104, the vibration of the motor 86 can be suppressed and the control circuit board 196 can be cooled with only one component.

The body housing 12 comprises the first battery receptacle 22 configured to have the first battery pack BP1 (example of first battery) configured to power the motor 86 detachably attached thereto, and the second battery receptacle 24 configured to have the second battery pack BP2 (example of second battery) configured to power the motor 86 detachably attached thereto.

According to the above configuration, the output of the motor unit 10 can be increased and/or the operating time of the motor unit 10 can be extended.

When the motor unit 10 is viewed along the front-rear direction, the control circuit board 196 at least partially overlaps the motor 86.

According to the above configuration, when the motor unit 10 is viewed along the front-rear direction, the motor unit 10 can be suppressed from becoming larger in the direction perpendicular to the front-rear direction as compared to a configuration in which the control circuit board 196 does not even at least partially overlap the motor 86.

The motor unit 10 in the present embodiment is configured to be detachably attached to the working unit 4 to drive the working unit 4. The motor unit 10 comprises the motor 86 comprising the motor shaft 140 extending in the front-rear direction (example of first direction) and configured to drive the working unit 4, the control circuit board 196 configured to drive the motor 86, the motor housing 84 supporting the motor 86, the body housing 12 disposed on the outer side of the control circuit board 196 and the motor housing 84, the second fixing part 150 configured to be fixed to the working unit 4, the first right vibration-proof member 170 (example of first vibration-proof member) disposed between the body housing 12 and the motor housing 84, and the first left vibration-proof member 176 (example of second vibration-proof member) disposed between the body housing 12 and the motor housing 84. The motor shaft 140 is substantially perpendicular to the second fixing part 150. In the up-down direction perpendicular to the placement surface P1, at least a part of the first right vibration-proof member 170 and at least a part of the first left vibration-proof member 176 are disposed below the upper end of the motor 86 when the motor unit 10 is placed on the placement surface P1. When the motor unit 10 is viewed along the front-rear direction, the motor 86 is disposed between the first right vibration-proof member 170 and the first left vibration-proof member 176.

According to the above configuration, at least a part of the first right vibration-proof member 170 and at least a part of the first left vibration-proof member 176 are disposed below the upper end of the motor 86, and the first right vibration-proof member 170 and the first left vibration-proof member 176 are disposed with the motor 86 in between them. Due to this, the first right vibration-proof member 170 and the first left vibration-proof member 176 are symmetrically positioned with respect to the motor 86. This allows the vibration of the motor 86 to be sufficiently damped.

The motor shaft 140 extends along the placement surface P1 when the motor unit 10 is placed on the placement surface P1. The first right vibration-proof member 170 and the first left vibration-proof member 176 are disposed below the central axis 140a of the motor shaft 140 when the motor unit 10 is placed on the placement surface P1.

Generally, the component(s) of the motor unit 10 are often disposed in the space above the upper end of the motor 86. According to the above configuration, the available space below the central axis 140a of the motor shaft 140 can be used.

The first right vibration-proof member 170 is the first distance away from the perpendicular plane P2 perpendicular to the placement surface P1 and including the front-rear direction. The first left vibration-proof member 176 is the first distance away from the perpendicular plane P2.

According to the above configuration, the distance between the first right vibration-proof member 170 and the perpendicular plane P2 is the same as the distance between the first left vibration-proof member 176 and the perpendicular plane P2. Therefore, the first right vibration-proof member 170 and the first left vibration-proof member 176 are symmetrically arranged with respect to the perpendicular plane P2. When the motor 86 vibrates, the first right vibration-proof member 170 and the first left vibration-proof member 176 deform more uniformly, for example. This allows the vibration of the motor 86 to be damped more.

The body housing 12 comprises the first battery receptacle 22 configured to have the first battery pack BP1 (example of first battery) configured to power the motor 86 detachably attached thereto, and the second battery receptacle 24 configured to have the second battery pack BP2 (example of second battery) configured to power the motor 86 detachably attached thereto.

According to the above configuration, the output of the motor unit 10 can be increased and/or the operating time of the motor unit 10 can be extended.

The motor unit 10 in the present embodiment is configured to be detachably attached to the working unit 4 to drive the working unit 4. The motor unit 10 comprises the motor 86 comprising the motor shaft 140 extending in the front-rear direction (example of first direction) and configured to drive the working unit 4, the control circuit board 196 configured to drive the motor 86, the fan 88 fixed to the motor 86, the motor housing 84 supporting the motor 86, the board housing 192 supporting the control circuit board 196, the body housing 12 disposed on the outer side of the motor housing 84 and the board housing 192, the fixing unit 90 configured to be fixed to the working unit 4, and the tubular vibration-proof member 104 disposed between the motor housing 84 and the board housing 192 and having a tubular shape. When the fan 88 rotates, the air cools the control circuit board 196 and passes inside the interior of the tubular vibration-proof member 104.

According to the above configuration, when the motor 86 vibrates, the tubular vibration-proof member 104 dampens the vibration of the motor 86. In addition, air cooling the control circuit board 196 passes inside the tubular vibration-proof member 104. By using the tubular vibration-proof member 104, the vibration of the motor 86 can be cooled and the control circuit board 196 can be cooled with only one component. This reduces the number of parts in the motor unit 10.

The motor unit 10 further comprises the plate member 92 fixed to the motor housing 84, the support unit 100 supporting the board housing 192, and the vibration-proof part 94 (example of vibration-proof member) fixed to the plate member 92 and the support unit 100.

According to the above configuration, the vibration of the motor 86 is damped by the tubular vibration-proof member 104 and the vibration-proof part 94. This suppresses the vibration from being transmitted to the control circuit board 196.

When the motor unit 10 is viewed along the front-rear direction, the tubular vibration-proof member 104 at least partially overlaps the motor 86.

According to the above configuration, when the motor unit 10 is viewed along the front-rear direction, the motor unit 10 can be suppressed from becoming larger in the direction perpendicular to the front-rear direction as compared to a configuration in which the tubular vibration-proof member 104 does not even at least partially overlap with the motor 86.

Further, the body housing 12 comprises the first battery receptacle 22 configured to have the first battery pack BP1 (example of first battery) configured to power the motor 86 detachably attached thereto, and the second battery receptacle 24 configured to have the second battery pack BP2 (example of second battery) configured to power the motor 86 detachably attached thereto.

According to the above configuration, the output of the motor unit 10 can be increased and/or the operating time of the motor unit 10 can be extended.

### Second Embodiment

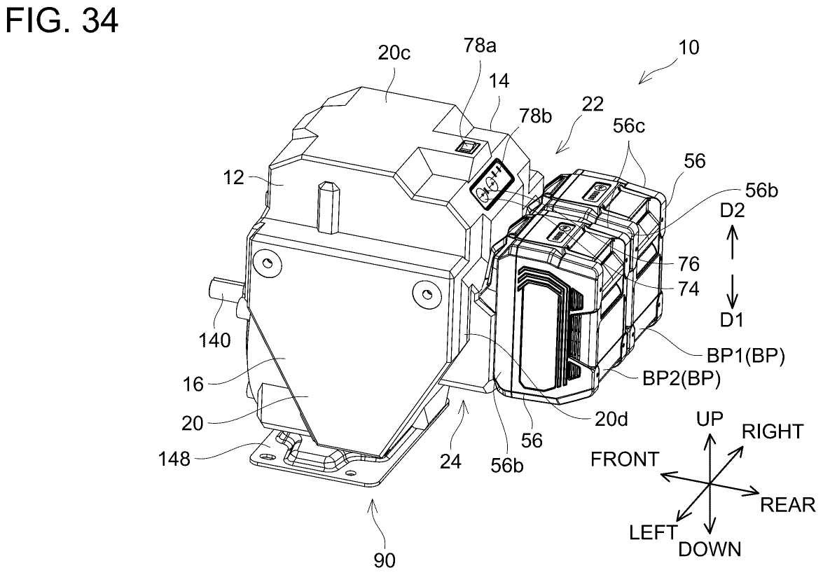

In a second embodiment, points that differ from the first embodiment will be described. As shown in FIG. 34, in the second embodiment, the first battery receptacle 22 and the second battery receptacle 24 are arranged on the rear wall 20d of the accommodating part 20. The first battery receptacle 22 and the second battery receptacle 24 are arranged side-by-side in the left-right direction. When the motor unit 10 is viewed along the front-rear direction, the first battery receptacle 22 does not overlap the second battery receptacle 24.

The first battery pack BP1 is attached to the first battery receptacle 22 by sliding it in the attaching direction D1 and removed from the first battery receptacle 22 by sliding it in the detaching direction D2, opposite to the attaching direction D1. The attaching direction D1 is downward. The detaching direction D2 is upward. The second battery pack BP2 is attached to the second battery receptacle 24 by sliding it in the first direction and removed from the second battery receptacle 24 by sliding it in the detaching direction D2.

### Third Embodiment

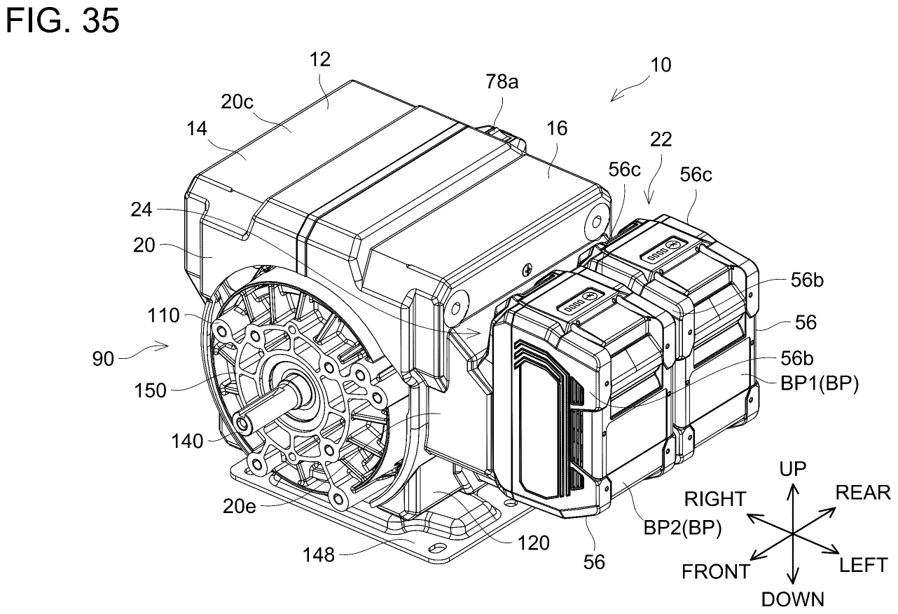

In a third embodiment, points that differ from the first embodiment will be described. As shown in FIG. 35, in the third embodiment, the first battery receptacle 22 and the second battery receptacle 24 are arranged on the left wall 20e of the accommodating part 20. The first battery receptacle 22 and the second battery receptacle 24 are arranged side-by-side in the front-rear direction. When the motor unit 10 is viewed along the left-right direction, the first battery receptacle 22 does not overlap the second battery receptacle 24.

The first battery pack BP1 is attached to the first battery receptacle 22 by sliding it in the attaching direction D1 and removed from the first battery receptacle 22 by sliding it in the detaching direction D2, opposite to the attaching direction D1. The attaching direction D1 is downward. The detaching direction D2 is upward. The second battery pack BP2 is attached to the second battery receptacle 24 by sliding it in the first direction and removed from the second battery receptacle 24 by sliding it in the detaching direction D2.

### Fourth Embodiment

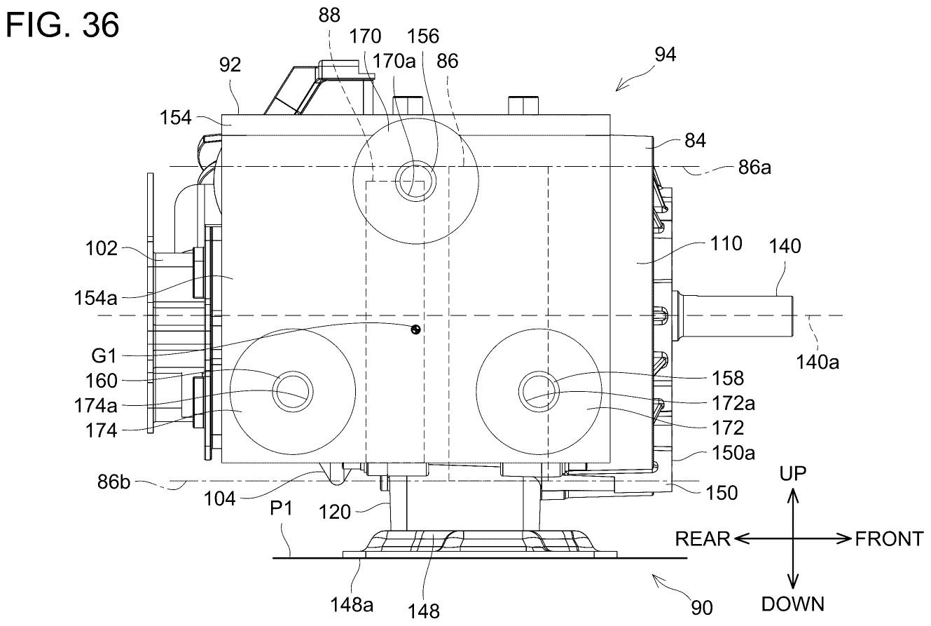

In a fourth embodiment, points that differ from the first embodiment will be described. As shown in FIG. 36, the first right vibration-proof member 170 is positioned above the center of gravity G1 of the motor unit 10 and the central axis 140a of the motor shaft 140. The center of the first right vibration-proof member 170 in the up-down direction is disposed below the upper end 86a of the motor 86. The upper end of the first right vibration-proof member 170 is disposed above the upper end 86a of the motor 86. With respect to the front-rear direction, the position of the center of the first right vibration-proof member 170 is substantially identical to the position of the center of gravity G1 of the motor unit 10.

The second right vibration-proof member 172 and the third right vibration-proof member 174 are disposed below the center of gravity G1 and the central axis 140a of the motor unit 10. The second right vibration-proof member 172 and the third right vibration-proof member 174 are disposed above the lower end 86b of the motor 86. With respect to the front-rear direction, the position of the center between the second right vibration-proof member 172 and the third right vibration-proof member 174 is substantially identical to the position of the center of gravity G1 of the motor unit 10.

The position of the first left vibration-proof member 176 (see FIG. 21) in the front-rear direction is substantially identical to the position of the first right vibration-proof member 170 in the front-rear direction. The position of the first left vibration-proof member 176 in the up-down direction is substantially identical to the position of the first right vibration-proof member 170 in the up-down direction. The position of the second left vibration-proof member 178 (see FIG. 21) in the front-rear direction is substantially identical to the position of the second right vibration-proof member 172 in the front-rear direction. The position of the second left vibration-proof member 178 in the up-down direction is substantially identical to the position of the second right vibration-proof member 172 in the up-down direction. The position of the third left vibration-proof member 180 (see FIG. 21) in the front-rear direction is substantially identical to the position of the third right vibration-proof member 174 in the front-rear direction. The position of the third left vibration-proof member 180 in the up-down direction is substantially identical to the position of the third right vibration-proof member 174 in the up-down direction.

### Fifth Embodiment

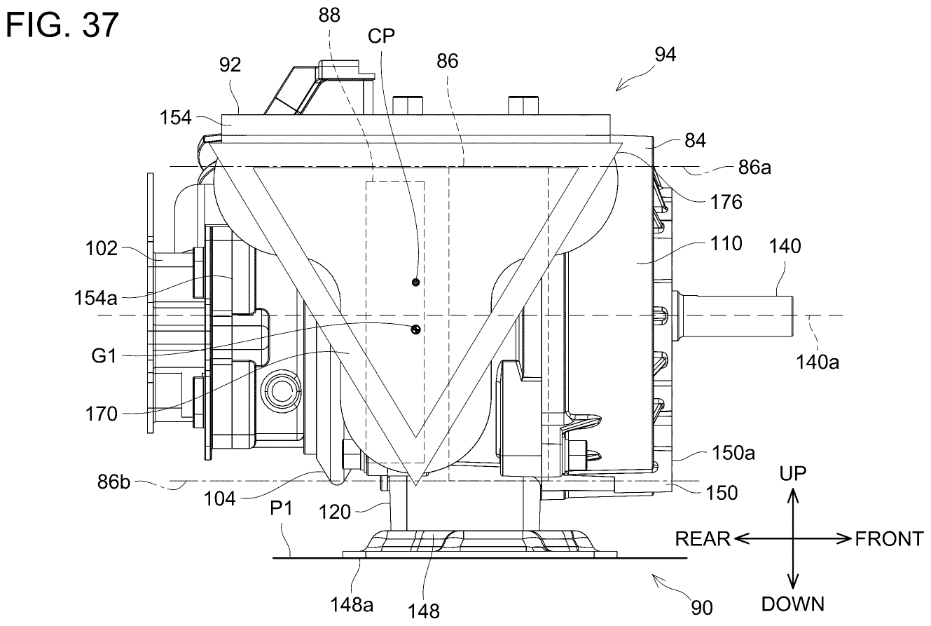

In a fifth embodiment, points that differ from the first embodiment will be described. As shown in FIG. 37, the vibration-proof part 94 comprises only the first right vibration-proof member 170 and the first left vibration-proof member 176. In FIG. 37, the first right vibration-proof member 170 is marked with a sign 176 on the outer surface of the first right vibration-proof member 170 to make the position of the first left vibration-proof member 176 easier to understand. The shape of the first right vibration-proof member 170 in the fifth embodiment differs from the shape of the first right vibration-proof member 170 of the first embodiment, and the shape of the first left vibration-proof member 176 in the fifth embodiment differs from the shape of the first left vibration-proof member 176 of the first embodiment.

The first right vibration-proof member 170 has a triangular ring shape. With respect to the first-back direction, the position of the center CP of the first right vibration-proof member 170 is identical to the position of the center of gravity G1 of the motor unit 10. The center CP of the first right vibration-proof member 170 is disposed above the center of gravity G1 of the motor unit 10 and the central axis 140a of the motor shaft 140. The upper end of the first right vibration-proof member 170 is disposed above the upper end 86a of the motor 86. The lower end of the first right vibration-proof member 170 is disposed below the lower end 86b of the motor 86. At least a portion of the first right vibration-proof member 170 is disposed below the upper end 86a of the motor 86.

The shape of the first left vibration-proof member 176 is substantially identical to the shape of the first right vibration-proof member 170. The position of the first left vibration-proof member 176 in the front-rear direction is substantially identical to the position of the first right vibration-proof member 170 in the front-rear direction. The position of the first left vibration-proof member 176 in the up-down direction is substantially identical to the position of the first right vibration-proof member 170 in the up-down direction.

### Variants

The motor unit 10 in one embodiment may comprise three or more battery receptacles. In this case, the three or more battery packs BP can be attached to the body housing 12.

In one embodiment of the motor unit 10, the attaching direction D1 of the first battery pack BP1 may be different from the attaching direction of the second battery pack BP2. The detaching direction D2 of the first battery pack BP1 may be different from the detaching direction of the second battery pack BP2.

In the motor unit 10 of the above embodiment, the first right vibration-proof member 170, the second right vibration-proof member 172, and the third right vibration-proof member 174 are fixed to the right wall 154a of the plate member 92. In a variant, the number of vibration-proof members fixed to the right wall 154a of the plate member 92 is not limited to three, but may be two or less, four or more.

In the motor unit 10 of the above embodiment, the first left vibration-proof member 176, the second left vibration-proof member 178, and the third left vibration-proof member 180 are fixed to the left wall 154b of the plate member 92. In a variant, the number of vibration-proof members fixed to the left wall 154b of the plate member 92 is not limited to three, but may be two or less, four or more.

What is claimed is:

1. A motor unit configured to be detachably attached to a working unit to drive the working unit, the motor unit comprising:
a motor comprising a motor shaft extending in a first direction and configured to drive the working unit;
a control circuit board configured to drive the motor;
a motor housing supporting the motor;
a body housing disposed on an outer side of the control circuit board and the motor housing;
a first fixing part configured to be fixed to the working unit;
a first vibration-proof member disposed between the body housing and the motor housing; and
a second vibration-proof member disposed between the body housing and the motor housing,
wherein
the first fixing part is configured to be placed on a placement surface when the motor unit is placed on the placement surface, the first fixing part being disposed substantially parallel to the motor shaft,
in an up-down direction perpendicular to the placement surface, at least a part of the first vibration-proof member and at least a part of the second vibration-proof member are disposed below an upper end of the motor when the motor unit is placed on the placement surface, and
when the motor unit is viewed along the first direction, the motor is disposed between the first vibration-proof member and the second vibration-proof member.

2. The motor unit according to claim 1, wherein
the motor shaft extends along the placement surface when the motor unit is placed on the placement surface, and
the first vibration-proof member and the second vibration-proof member are disposed below a central axis of the motor shaft when the motor unit is placed on the placement surface.

3. The motor unit according to claim 2, wherein the first vibration-proof member and the second vibration-proof member are disposed above a lower end of the motor when the motor unit is placed on the placement surface.

4. The motor unit according to claim 2, wherein
the first vibration-proof member is a first distance away from a perpendicular plane perpendicular to the placement surface and including the first direction, and
the second vibration-proof member is the first distance away from the perpendicular plane.

5. The motor unit according to claim 2, wherein a position of a center of gravity of the motor unit in the first direction is substantially same as each of a center position of the first vibration-proof member in the first direction and a center position of the second vibration-proof member in the first direction.

6. The motor unit according to claim 2, further comprising:
a third vibration-proof member disposed between the body housing and the motor housing; and
a fourth vibration-proof member disposed between the body housing and the motor housing,
wherein
at least a part of the third vibration-proof member and at least a part of the fourth vibration-proof member are disposed above the central axis of the motor shaft when the motor unit is placed on the placement surface, and
when the motor unit is viewed along the first direction, the motor is disposed between the third vibration-proof member and the fourth vibration-proof member.

7. The motor unit according to claim 6, wherein the third vibration-proof member is disposed on a same side as the first vibration-proof member relative to a perpendicular plane perpendicular to the placement surface and including the first direction,
the fourth vibration-proof member is disposed on a same side as the second vibration-proof member relative to the perpendicular plane, and
a distance between the first vibration-proof member and the third vibration-proof member is substantially same as a distance between the second vibration-proof member and the fourth vibration-proof member.

8. The motor unit according to claim 1, further comprising a plate member fixed to the motor housing,
wherein the first vibration-proof member and the second vibration-proof member are fixed to the plate member and the body housing.

9. The motor unit according to claim 1, further comprising a second fixing part configured to be fixed to a working unit of a type different from the working unit fixed to the first fixing part.

10. The motor unit according to claim 1, further comprising:
a fan fixed to the motor;
a board housing supporting the control circuit board; and
a tubular vibration-proof member disposed between the motor housing and the board housing and having a tubular shape,
wherein when the fan rotates, air cools the control circuit board and passes inside the tubular vibration-proof member.

11. The motor unit according to claim 1, wherein the body housing comprises:
a first battery receptacle configured to have a first battery configured to power the motor detachably attached thereto; and
a second battery receptacle configured to have a second battery configured to power the motor detachably attached thereto.

12. The motor unit according to claim 1, wherein when the motor unit is viewed along the first direction, the control circuit board at least partially overlaps the motor.

13. The motor unit according to claim 3, wherein the first vibration-proof member is a first distance away from a perpendicular plane perpendicular to the placement surface and including the first direction,
the second vibration-proof member is the first distance away from the perpendicular plane,
a position of a center of gravity of the motor unit in the first direction is substantially same as each of a center position of the first vibration-proof member in the first direction and a center position of the second vibration-proof member in the first direction,
the motor unit further comprises:
a third vibration-proof member disposed between the body housing and the motor housing; and
a fourth vibration-proof member disposed between the body housing and the motor housing,
at least a part of the third vibration-proof member and at least a part of the fourth vibration-proof member are disposed above the central axis of the motor shaft when the motor unit is placed on the placement surface,
when the motor unit is viewed along the first direction, the motor is disposed between the third vibration-proof member and the fourth vibration-proof member,
the third vibration-proof member is disposed on a same side as the first vibration-proof member relative to the perpendicular plane,
the fourth vibration-proof member is disposed on a same side as the second vibration-proof member relative to the perpendicular plane,
a distance between the first vibration-proof member and the third vibration-proof member is substantially same as a distance between the second vibration-proof member and the fourth vibration-proof member,
the motor unit further comprises a plate member fixed to the motor housing,
the first vibration-proof member and the second vibration-proof member are fixed to the plate member and the body housing,
the motor unit further comprises:
a second fixing part configured to be fixed to a working unit of a type different from the working unit fixed to the first fixing part,
a fan fixed to the motor;
a board housing supporting the control circuit board; and
a tubular vibration-proof member disposed between the motor housing and the board housing and having a tubular shape,
when the fan rotates, air cools the control circuit board and passes inside the tubular vibration-proof member,
the body housing comprises:
a first battery receptacle to which a first battery configured to power the motor is configured to be detachably attached; and
a second battery receptacle to which a second battery configured to power the motor is configured to be detachably attached, and
when the motor unit is viewed along the first direction, the control circuit board at least partially overlaps the motor.

14. A motor unit configured to be detachably attached to a working unit to drive the working unit, the motor unit comprising:
a motor comprising a motor shaft extending in a first direction and configured to drive the working unit;
a control circuit board configured to drive the motor;
a motor housing supporting the motor;
a body housing disposed on an outer side of the control circuit board and the motor housing;
a second fixing part configured to be fixed to the working unit;
a first vibration-proof member disposed between the body housing and the motor housing; and
a second vibration-proof member disposed between the body housing and the motor housing,
wherein the motor shaft is substantially perpendicular to the second fixing part,
in an up-down direction perpendicular to a placement surface, at least a part of the first vibration-proof member and at least a part of the second vibration-proof member are disposed below an upper end of the motor when the motor unit is placed on the placement surface, and
when the motor unit is viewed along the first direction, the motor is disposed between the first vibration-proof member and the second vibration-proof member.

15. The motor unit according to claim 14, wherein the motor shaft extends along the placement surface when the motor unit is placed on the placement surface, and
the first vibration-proof member and the second vibration-proof member are disposed below a central axis of the motor shaft when the motor unit is placed on the placement surface.

16. The motor unit according to claim 15, wherein the first vibration-proof member is a first distance away from a perpendicular plane perpendicular to the placement surface and including the first direction, and
the second vibration-proof member is the first distance away from the perpendicular plane.

17. The motor unit according to claim 14, wherein the body housing comprises:
a first battery receptacle configured to have a first battery configured to power the motor detachably attached thereto; and
a second battery receptacle configured to have a second battery configured to power the motor detachably attached thereto.

18. A motor unit configured to be detachably attached to a working unit to drive the working unit, the motor unit comprising:
a motor comprising a motor shaft extending in a first direction and configured to drive the working unit;
a control circuit board configured to drive the motor;
a fan fixed to the motor;
a motor housing supporting the motor;
a board housing supporting the control circuit board;
a body housing disposed on an outer side of the motor housing and the board housing;
a fixing unit configured to be fixed to the working unit; and
a tubular vibration-proof member disposed between the motor housing and the board housing and having a tubular shape,
wherein when the fan rotates, air cools the control circuit board and passes inside the tubular vibration-proof member.

19. The motor unit according to claim 18, further comprising:
a plate member fixed to the motor housing;
a support unit supporting the board housing; and
a vibration-proof member fixed to the plate member and the support unit.

20. The motor unit according to claim 18, wherein when the motor unit is viewed along the first direction, the tubular vibration-proof member at least partially overlaps the motor.

21. The motor unit according to claim 18, wherein the body housing comprises:
a first battery receptacle to which a first battery configured to power the motor is configured to be detachably attached; and
a second battery receptacle to which a second battery configured to power the motor is configured to be detachably attached.
